(19) United States
(12) Patent Application Publication
(10) Pub. No.: US 2004/0117473 A1
(43) Pub. Date: Jun. 17, 2004

(54) Proxy network control apparatus

(76) Inventors: Shinya Yamamura, Fukuoka (JP); Yoshiharu Sato, Fukuoka (JP); Katsuichi Nakamura, Fukuoka (JP); Tatsuo Horiguchi, Fukuoka (JP)

Correspondence Address: KATTEN MUCHIN ZAVIS ROSENMAN, 575 MADISON AVENUE, NEW YORK, NY, 10022-2585, US

(21) Appl. No.: 10/723,275

(22) Filed: Nov. 25, 2003

(30) Foreign Application Priority Data
Nov. 29, 2002 (JP) 2002-346949

(51) Int. Cl. G06F 15/173

(52) U.S. Cl. 709/223

(57) ABSTRACT

A proxy network control unit (PNCU) 1 is set where it can monitor packets communicated between a user terminal 3 and a service server 2 which provide predermined services to the user terminal 3. PNCU 1 monitors the packets communicated between a user terminal 3 and a service server 2, executes functions complementing or expanding the functions of the service server 2 by controlling at least one of network equipments 41-4n based on the packets. For example, in case a service server 2 is DHCP server, PNCU 1 controls the network equipment so as that only packets which source address match an IP address the DHCP server issued to the user terminal 3, are transferred.

### BACKGROUND OF THE INVENTION

1. Field of the Invention

The present invention relates generally to a proxy network control apparatus for executing network functions as a substitute, and more particularly to a proxy network control apparatus for substituting for service equipment providing predetermined services to user terminals, and executing functions complementing or expanding the functions of the service equipment.

Furthermore, the invention relates to a program executed by a computer for executing network functions as a substitute, and more particularly to a program for causing a computer to execute functions complementing or expanding the functions of service equipment providing predetermined services to user terminals, in lieu of the service equipment.

Yet furthermore, the invention relates to a network system having such a proxy network control apparatus.

2. Description of the Related Art

With the prevalence of the Internet (IP network), the environment where accesses can be made freely from anywhere to the IP network is getting completed. Such an environment improves the convenience for users utilizing the network while it gives problems to network managers in terms of security because anybody can connect with the network.

Especially according to the protocols such as DHCP (Dynamic Host Configuration Protocol) and IPv6, a user can make an access to the network even when the user does not have the information on the address where the user would like to make an access since an address is automatically created and issued to the user.

Therefore, from now on, access regulation for restricting the accesses from the users having no authorization for making accesses will be important in terms of security.

Suggestions to execute access regulation have been made including one in which network equipment having an access regulation function and an authentication apparatus for authenticating users are combined, and another in which access regulation is executed by adding a control function of network equipment to a DHCP server executing the DHCP, and some products are actually emerging (see, for example, Patent Documents 1-4).

As a controlling method when a terminal connects to a network, accepting the connection from a user terminal to the network after authenticating the user by a combination of a control server (an authentication server, a DHCP server etc.) and a control apparatus (a fire wall, a packet shaping apparatus etc.) is performed in the conventional technique.

As an apparatus for performing the network functions as a substitute, a proxy server caches WEB contents and provides the cached WEB contents to users as a substitute being another server than the server providing the original of the contents. There are two (2) types of proxy servers such as the one for which users designate the address of a server explicitly, and the one called a transparent-type proxy server as which a network captures packets forcibly and executes the functions of a proxy server.

As a mechanism for executing the control of a network according to a predetermined guideline, there is a Policy Based Network (PBN). The PBN comprises a policy detection point for capturing the designated packets, a policy server for determining a policy for the captured packets and a policy implementation point for executing the control of the traffic to be controlled, based on the determined policy.

An apparatus for monitoring the traffic is a protocol monitor such as sniffer and ethereal.

[Patent Document 1]

Japanese Patent Application Laid-open Pub No. 2001-326696

[Patent Document 2]

Japanese Patent Application Laid-open Pub. No. 2001-36561

[Patent Document 3]

Japanese Patent Application Laid-open Pub. No. 2001-274806

[Patent Document 4]

Japanese Patent Application Laid-open Pub. No. 1999-243389

However, in the case where a new function is added to a DHCP server, it is necessary to replace the DHCP server that has been used with a new one or to change the program and hardware of the existing DHCP server, and it may be necessary to change the existing network configuration itself. Furthermore, as to IPv6, the current status is that only suggestions have been made and there has been no apparatus present for it.

In the scheme in which an authentication server and a control apparatus are combined, the combination of the authentication server and the control apparatus is determined depending on the control software of the authentication server because the authentication server executes access control to the control apparatus. Therefore, it is necessary for a network operator who is planning to introduce an access regulation-service to purchase a new authentication server and a control apparatus together as a set and to incorporate them into the network, resulting in a higher cost.

A proxy server is manufactured to be dedicated mainly to HTTP protocol and it supports only a limited number of protocols such as RTP in addition to the HTTP protocol. Furthermore, a proxy server only has a function for either of answering with the cached information as a response to a HTTP request from a user, or executing communication with a server storing the original of the contents, as a substitute for an user terminal, and does not have any function for complementing a specific service.

A transparent proxy forcibly intercepts the HTTP protocol. However, the proxy server completes the process within it in any case and its operation does not differ from that of an ordinary proxy. Furthermore, a proxy server uses a URL as the information used for access regulation and it can only execute functions different from the access regulation of the network.

A PBN monitors packets and controls the packets based on a predetermined guideline. However, a packet monitoring apparatus and a policy server have to be introduced to the network. Therefore, according to a PBN, it is necessary to introduce a new apparatus to the network and to change the configuration of the network.

Furthermore, in a PBN, the conditions for determining a policy depends on IP header information such as P addresses and port numbers and it is not generally adapted to operate analyzing the details of a protocol.

A protocol monitor has a function for analyzing protocols for displaying. However, it does not have any function for performing some operation based on the analyzed protocol nor any function for cooperating with any other network equipment.

### SUMMARY OF THE INVENTION

The present invention was conceived in view of such a background and its object is to provide a proxy network control apparatus and a network system having the proxy network control apparatus, capable of complementing or expanding the functions of a network, especially the functions of service equipment providing services to user terminals, without modifying or changing the existing apparatuses on the network and the configuration of the network.

In order to achieve the above object, a first aspect of the present invention provides a proxy network control apparatus for substituting for service equipment providing predetermined services to user terminals, and executing functions complementing or expanding the functions of the service equipment, having a packet monitoring unit for monitoring packets interchanged between the user terminal and the service equipment; and an execution unit for determining and executing the functions complementing or expanding, based on packets-monitored by the packet monitoring unit.

A second aspect of the present invention provides a proxy network control apparatus for executing functions complementing or expanding functions of service equipment as a substitute for the service equipment by controlling network equipment transferring packets interchanged between a user terminal and the service equipment, arranged between the user terminal and the service equipment providing predetermined services to the user terminal, having a packet monitoring unit for monitoring packets interchanged between the user terminal and the service equipment; a service control unit for determining the functions complementing or expanding based on the packets monitored by the packet monitoring unit; and an external equipment control unit for controlling the network equipment based on the functions determined by the service control unit.

According to the invention, it is not necessary to add any function to service equipment nor change or modify the service equipment since the proxy network control apparatus substitutes for service equipment and executes functions complementing or expanding the functions of the service equipment. Thereby, the existing network resources can be used as it is and, therefore, the costs can be reduced. Furthermore, the proxy network control apparatus can be installed anywhere where the packets transmitted between service equipment and user terminals can be monitored. For example, the proxy network control apparatus can be connected with a monitoring interface held by network equipment. Thereby, it is possible to incorporate the proxy network control apparatus into the existing network.

A third aspect of the present invention provides a network system having service equipment for communicating with a user terminal and providing predetermined services to the user terminal; and a proxy network control apparatus for monitoring packets interchanged between the user terminal and the service equipment and executing functions complementing or expanding the functions of the service equipment based on the packets meeting predetermined conditions.

A fourth aspect of the present invention provides a program for causing a computer to execute steps of monitoring packets interchanged between a user terminal and service equipment providing predetermined services to the user terminal; and determining and executing functions for complementing or expanding the functions of the service equipment based on the monitored packets, in lieu of the service equipment.

A fifth aspect of the present invention provides a program for causing a computer for executing functions complementing or expanding functions of service equipment as a substitute for the service equipment by controlling network equipment transferring packets interchanged between a user terminal and the service equipment, arranged between the user terminal and the service equipment providing predetermined services to the user terminal, to execute the steps of monitoring packets interchanged between the user terminal and the service equipment; determining the functions for complementing or expanding based on the monitored packets: and controlling the network equipment based on the determined functions.

According to the program of the invention, it is also possible to obtain the same operational advantages as those according to the proxy network control apparatus of the invention described above.

A sixth aspect of the present invention provides a network system having service equipment for communicating with a user terminal and providing predetermined services to the user terminal; network equipment arranged between the user terminal and the service equipment, for transferring packets interchanged between the user terminal and the service equipment; and a proxy network control apparatus for monitoring packets interchanged between the user terminal and the service equipment and for executing functions complementing or expanding the functions of the service equipment as a substitute for; the service equipment by controlling the network equipment based on the packets meeting predetermined conditions.

According to the network system of the invention, similarly to the above, the existing network resources can also be used without modifying or changing them. Furthermore, it is possible to incorporate the proxy network control apparatus into the network without modifying or changing the network configuration.

### BRIEF DESCRIPTION OF THE DRAWINGS

The above and other objects, aspects, features and advantages of the present invention will become more apparent from the following detailed description when taken in conjunction with the accompanying drawings, in which:

FIGS. 1A to 1D are block diagrams showing configuration examples of a network system having a proxy network control apparatus (PNCU) according to an embodiment of the invention;

FIG. 2 is a functional block diagram of the PNCU;

FIG. 3 shows a configuration example of an address list;

FIG. 4 shows a configuration example of a service management table;

FIG. 5 shows a configuration example of an access list;

FIG. 6 is a flowchart showing the flow of an initial setting process unit of the PNCU;

FIG. 7 is a flowchart showing the flow of a packet monitoring unit of the PNCU;

FIG. 8 is a flowchart showing the process flow of a service control unit of the PNCU;

FIG. 9 is a flowchart showing the process flow of an external equipment control unit of the PNCU;

FIG. 10 is a flowchart showing the process flow of a periodic process unit of the PNCU;

FIG. 11A illustrates a problem of a network in terms of security, that arise when address allocation (paying out) to a user terminal is executed by the DHCP server;

FIG. 11B is a configuration diagram of a network for the case where this problem is solved by the conventional technique;

FIG. 11C is a configuration diagram of a network system for the case where this problem is solved by the PNCU;

FIGS. 12A, 12B and 12C respectively show an example of an address list, an example of a service management table and an example of an access list;

FIG. 13 is a flowchart showing the process flow of DHCP_INIT;

FIG. 14 is a flowchart showing the process flow of DHCP_SET;

FIG. 15 is a flowchart showing the process flow of DHCP_REL;

FIG. 16 is a sequence diagram showing a message flow for the time when an address is paid-out at the DHCP;

FIG. 17 is a sequence diagram showing a message flow for the time when the address is returned in DHCP;

FIG. 18A shows a format of a DHCP message and FIG. 18B and FIG. 18C show options;

FIG. 19A illustrates a problem arising in the case where an FW is installed according to Mobile IPv4;

FIG. 19B is a configuration diagram of a network system for the case where this problem is solved by the conventional technique;

FIG. 19C is a configuration diagram of a network system for the case where this problem is solved by the PNCU;

FIGS. 20A, 20B and 20C respectively show an example of the address list, an example of the service management table and an example of the access list;

FIG. 21 is a flowchart showing the process flow of MobileIP_INIT;

FIG. 22 is a flowchart showing the process flow of MobileIP_REP;

FIG. 23 is a flowchart showing the process flow of MobileIP_REQ;

FIG. 24 is a location registration sequence diagram of Mobile IPv4;

FIG. 25A is a packet configuration diagram of Registration Request of Mobile IPv4;

FIG. 25B is a packet configuration diagram of Registration Reply of Mobile IPv4;

FIG. 26A shows the overview of an access regulation scheme according to IPv6 proposed in IETF;

FIGS. 26B and 26C are configuration diagrams of a network system for the case where access regulation is executed by the PNCU;

FIGS. 27A, 27B and 27C respectively show an example of the address list an example of the service management table and an example of the access list;

FIG. 28 is a flowchart showing the process flow of IPV6_INIT;

FIG. 29 is a flowchart showing the process flow of IPV6_SET;

FIG. 30 is a flowchart showing the process flow of IPV6_REL;

FIG. 31 is an authentication sequence diagram of IPv6;

FIG. 32 shows the packet configuration of a ICMP AAA message; and

FIG. 33 shows an explicit ending sequence of IPv6.

### DESCRIPTION OF THE PREFERRED EMBODIMENTS

<Network System Configuration>

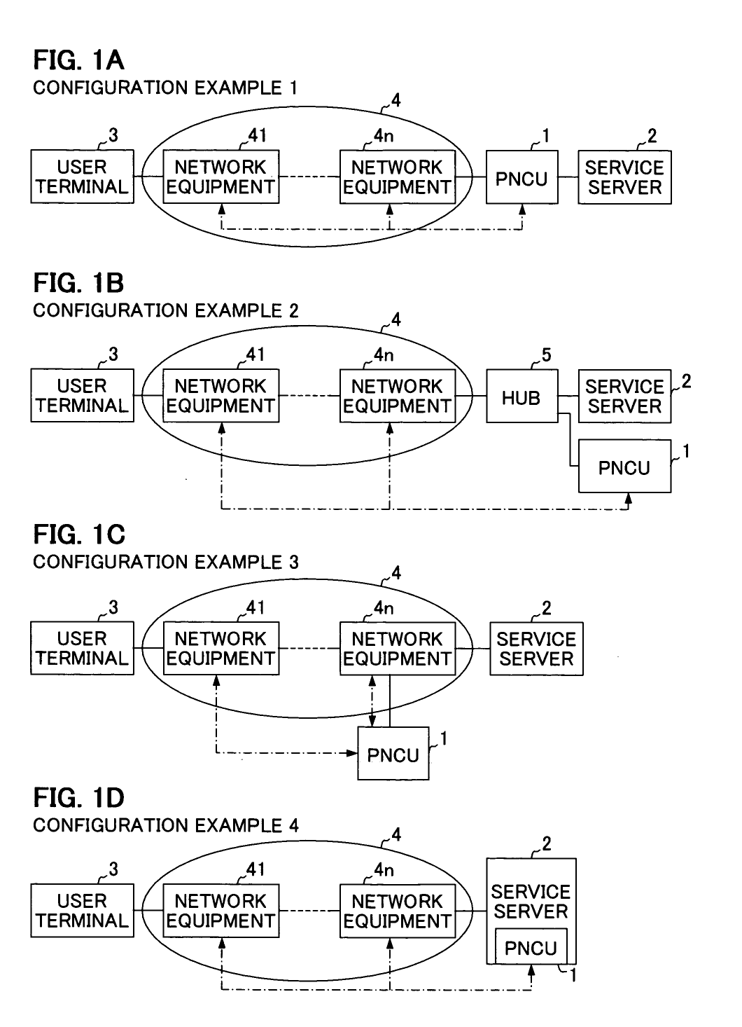

FIGS. 1A to 1D are block diagrams showing examples of the configuration of a network system having a proxy network control unit (PNCU) according to an embodiment of the invention.

Network systems shown in FIGS. 1A, 1C and 1D respectively have a PNCU 1, a service server 2, a user terminal 3 and one (1) or more (n in FIGS. 1A to 1D, n is a positive integer) network equipment 41-4n provided to a network 4. A network system shown in FIG. 1B further has a hub 5 in addition to these components.

The network 4 is, for example, an IP network and is configured with network equipment 41-4n for transferring packets. The network equipment 41-4n are apparatuses for transferring packets and respectively include, for example, a router, a hub, an L3 switch (Layer 3 switch), a firewall, a gateway server, an NAT (Network Address Translation) server, an NAPT (Network Address Port Translation) server, a proxy server etc.

The user terminal 3 is a terminal for communicating with the service server 2 through the network 4 and for receiving services from the service server 2. The examples of the user terminal 3 include a desktop PC, a note PC, PDA (Personal Digital Assistant) etc.

The service server 2 is a server for providing various services to the user terminal 3 in response to the request from the user terminal 3. Examples of the service server 2 include, for example, a DHCP server, an authentication server and a policy server etc. for executing network accesses and network control, in addition to WEB servers for providing information.

Communication is executed between the user terminal 3 and the service server 2 according to a protocol for services and the user terminal 3 can receive services from the service server 2. Examples of the protocol for services include a DHCP (Dynamic Host Configuration Protocol) for an automatic IP address allocation service and an authentication protocol for an authentication service.

The PNCU 1 is an apparatus (or a program) for complementing those functions that the existing network does not have, without modifying or changing the apparatuses on the existing network (for example, the service server 2, the network equipment 41-4n, the hub 5, the user terminal 3 etc.) and configuration of the network, by controlling all or some of the network equipment 41-4n. The functions to be complemented for the existing network are securing of the network security (for example, exclusion of accesses to the network by users not registered in the network), securing of communication by packets at the firewall according to a mobile IP (hole-making of firewalls) etc.

Since PNCU 1 complements those functions that the existing network does not have, without modifying or changing the apparatuses on the existing network and configuration of the network, costs of modification or changes of the components on the network and the configuration can be reduced. The detailed configuration of the PNCU 1 will be described later.

In order to control the network equipment 41-4n, communication according to a protocol for controlling apparatuses is performed between the PNCU 1 and the network equipment 41-4n. Examples of protocols for controlling apparatuses include a command line interface according to Telnet, SNMP (Simple Network Management Protocol) etc.

The PNCU 1 monitors the packets interchanged between the user terminal 3 and the service server 2 in order to execute the complementing of the functions. Monitoring of all the packets by such a PNCU 1 can be executed in either of the configurations shown in FIGS. 1A to 1D.

That is, in a configuration example shown in FIG. 1A, the PNCU 1 is inserted into a communication path between the user terminal 3 and the service server 2, and all the traffic (messages and packets) between the user terminal 3 and the service server 1 is interchanged via the PNCU 1. Therefore, the PNCU 1 can monitor all the packets interchanged between the user terminal 3 and the service server 2.

In a configuration example 2 shown in FIG. 1B, the hub 5 being network equipment to which the lines from a plurality of user terminals or servers concentrate, is provided between the network equipment 4n and the service server 2. The PNCU 1 is connected with the hub 5 connected with the service server 2. In this configuration, packets transmitted from the hub 5 to the service server 2 or user terminal 3 are broadcast at a transmission layer (Layer 2 of an OSI hierarchical model) to all the apparatuses connected with the hub 5. Therefore, the PNCU 1 can receive and monitor the packets interchanged between the user terminal 3 and the service server 2. The hub 5 may be provided between the user terminal 3 and the network equipment 41.

In the configuration example 3 shown in FIG. 1C, the PNCU 1 is connected with a monitoring interface of any of the network equipment (network equipment 4n in FIG. 1C) present on the communication path between the user terminal 3 and the service server 2. The monitoring interface of the network equipment is an interface for monitoring packets and all the packets passing through the network equipment are outputted from the monitoring interface. Therefore, also in this configuration, the PNCU 1 can monitor the packets interchanged between the user terminal 3 and the service server 2.

In the configuration example 4 shown in FIG. 1D, the PNCU 1 is integrated in the service server 2. For example, the PNCU 1 is realized by a program and started up on the service server 2. Also in this configuration, the PNCU 1 can monitor the packets interchanged between the service server 2 and the user terminal 3.

<Configuration of the PNCU>

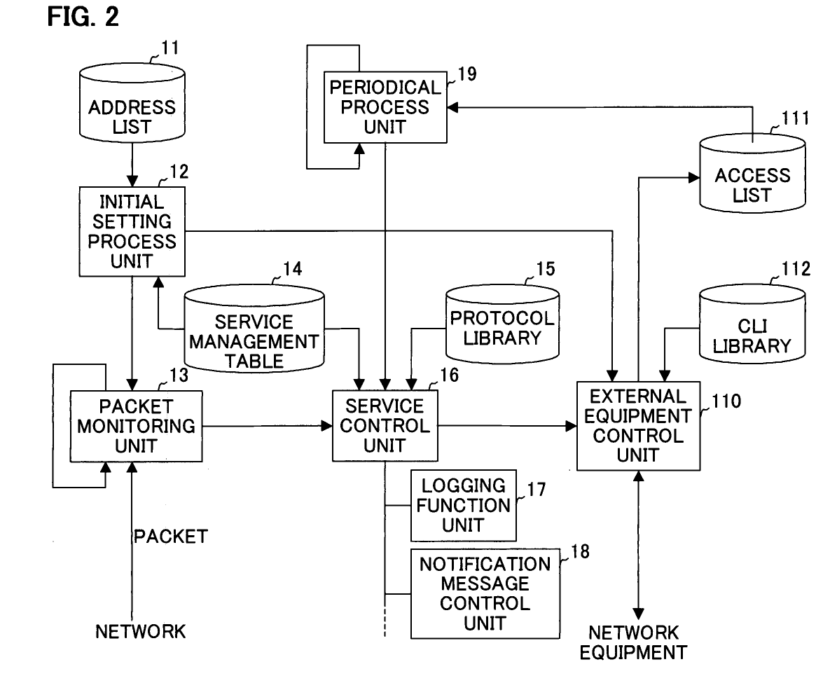

FIG. 2 is a functional block diagram of the PNCU 1. The PNCU 1 has an address list 11, a service management table 14, an access list 111, an initial setting process unit 12, a packet monitoring unit 13, a service control unit 16, a logging function unit 17, a notification message control unit 18, a periodical process unit 19, an external equipment control unit 110, a protocol library 15, and a command line interface (CLI) library 112.

Each functional block can either be configured by a program or by a hardware circuit. In the case where each functional block is configured by a program, this program is called from a non-volatile memory (such as a hard disk) of the PNCU 1 to a semiconductor memory (such as an RAM) at the start-up of the PNCU 1 and run by a CPU of the PNCU 1.

The address list 11 is data to be referred to for determining the target of the initial setting operation at the start-up of the PNCU 1 and stored in, for example, a non-volatile memory (such as a hard disk).

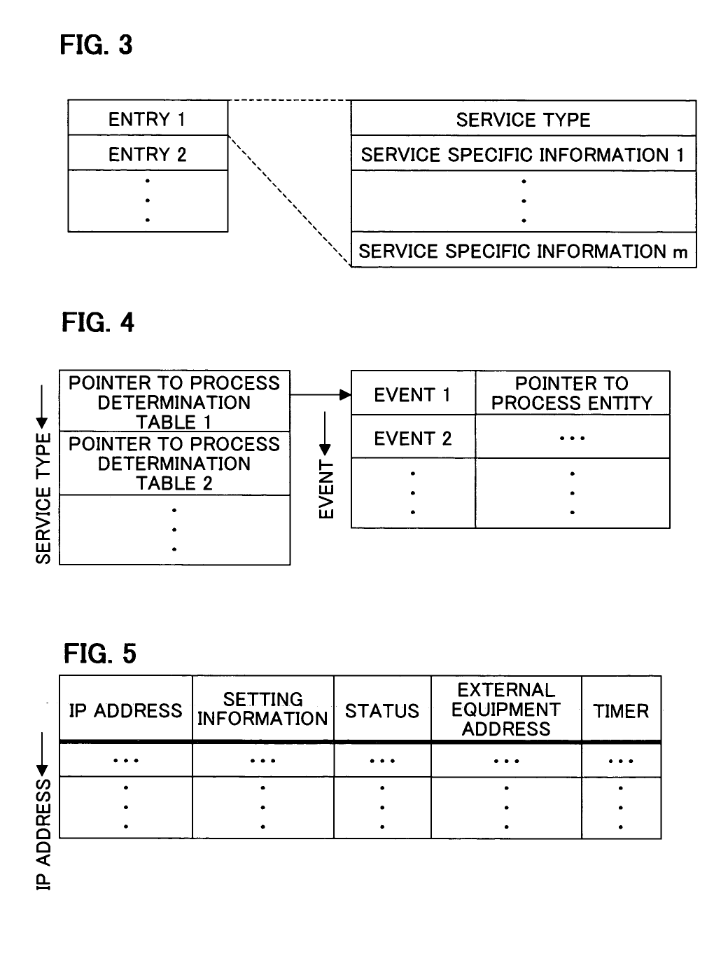

FIG. 3 shows a configuration example of the address list 11. The address list 11 has a plurality of entries. Each entry has service types indicating the types of services provided by the PNCU 1 (the function for complementing for the network), and a plurality of pieces of service-specific information. Each piece of service-specific information is, for example, an IP address of the user terminal to be the target of access regulation.

The service management table 14 is a transaction having pointers to a process determination table for each of service types, as entries and is stored in, for example, in a non-volatile memory (such as an RAM), and its contents is changed dynamically by the operation of the PNCU 1.

FIG. 4 shows a configuration example of the service management table 14. The service management table 14 has pointers to the process determination table retrieved using the service types, as entries and each pointer has an pointers to event names and process entity (such as a program).

The access list 111 is a transaction for the external equipment control unit 110 to manage the control of the external equipment (the network equipment being the targets of control) and is stored in, for example, a non-volatile memory (such as an RAM), and its contents is changed dynamically by the operation of the PNCU 1.

FIG. 5 shows a configuration example of the access list 111. The access list 111 has an entry for each of the IP addresses of the user terminals being the targets for setting to the external equipment. Each entry has a timer limiting the expiration time of an IP address of the user terminal and setting information to the external equipment, status, the external equipment addresses and entries.

The protocol library 15 is configured by the message type definition of a protocol for which analysis is necessary for providing services and a message analysis program. The protocol library 15 is referred to from the process entity for each event referred to from the service management table 14.

The CLI library 112 has a command line definition sentence configured by the characters defining commands to be sent to the network equipment 41-4n, a command line compiling program compiling the command lines by embedding variable parameters in the command line definition sentences and a communication library (for example, Telnet) for sending the commands. Each network equipment can have a different command line definition sentence and a different communication library for itself.

The initial setting process unit 12 is a program started up first at the start-up of the PNCU 1 and executes initial setting operation in response to the service functions to be provided. As an example of the initial setting operation, when the access regulation service is provided, setting of an access regulation filter to network equipment for a user terminal being the target of the provision of the service can be listed.

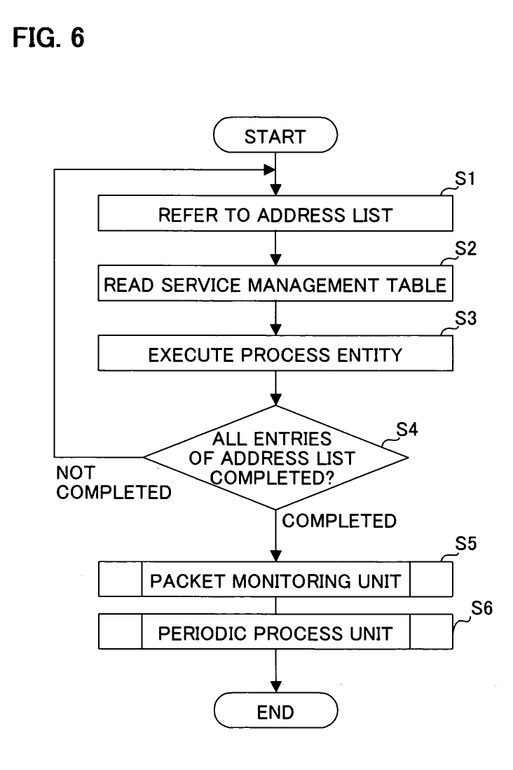

FIG. 6 is a flowchart showing the flow of the processes of the initial setting process unit 12.

First, the initial setting process unit 12 reads one (1) of the entries in the address list 11 (see FIG. 3) (S1). Then, the initial setting process unit 12 reads the pointer to the process determination table of the service management table 14 (see FIG. 4) retrieved by a service type in the entries having been read (S2).

Then, the initial setting process unit 12 searches the process determination table with an event (the initial setting) and executes the process entity (for example, a program) indicated by the pointer in the entry (S3). The process of the process entity differs by service. As the typical operation of the process entity, setting of an access regulation filter to the network equipment 41-4n through the external equipment control unit 110, setting of packet monitoring conditions to the packet monitoring unit 13, etc. can be listed.

After the process of the process entity has been completed, the initial setting process unit 12 determines whether or not the reading of all the entries of the address list 11 has been completed (S4) and, if the reading has not been completed, it executes the processes S1-S3 again and, if the reading has completed, after it has started up the packet monitoring unit 13 (S5), it starts up the periodic process unit 19 (S6) and the process is ended.

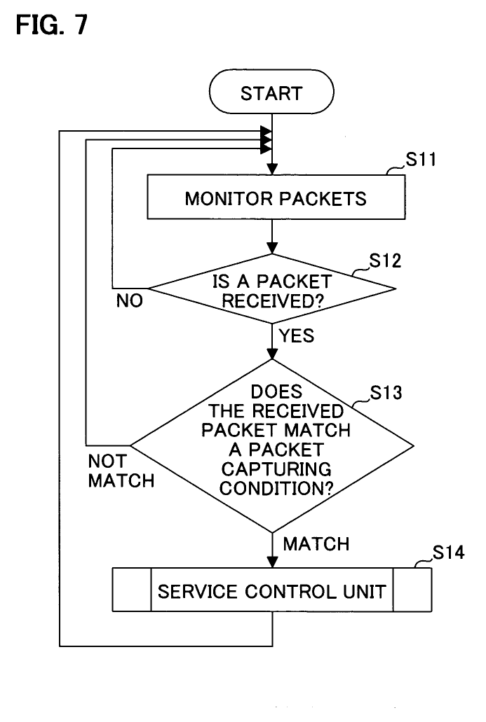

The packet monitoring unit 13 is started up by the initial setting process unit 12 and it monitors packets according to the conditions set by the initializing operation of the initial setting process unit 12. FIG. 7 is a flowchart showing the flow of the processes of the packet monitoring unit 13.

The packet monitoring unit 13 is in a status of waiting for receiving the packets and monitors the packets received (S11, S12). Then, when the packet monitoring unit 13 has received a packet (YES of S12), it determines whether or not the received packet matches the packet capturing conditions set by the initial setting process unit 12 (S13).

If the received packet matches the packet capturing condition (MATCH in S13), the unit 13 provides the received packet to the service control unit 16 and starts up the service control unit 16 (S14). On the other hand, if the received packet does not match the packet capturing conditions (NOT MATCH of S13), the packet monitoring unit 13 returns to the status of waiting for receiving packets again (S11, S12).

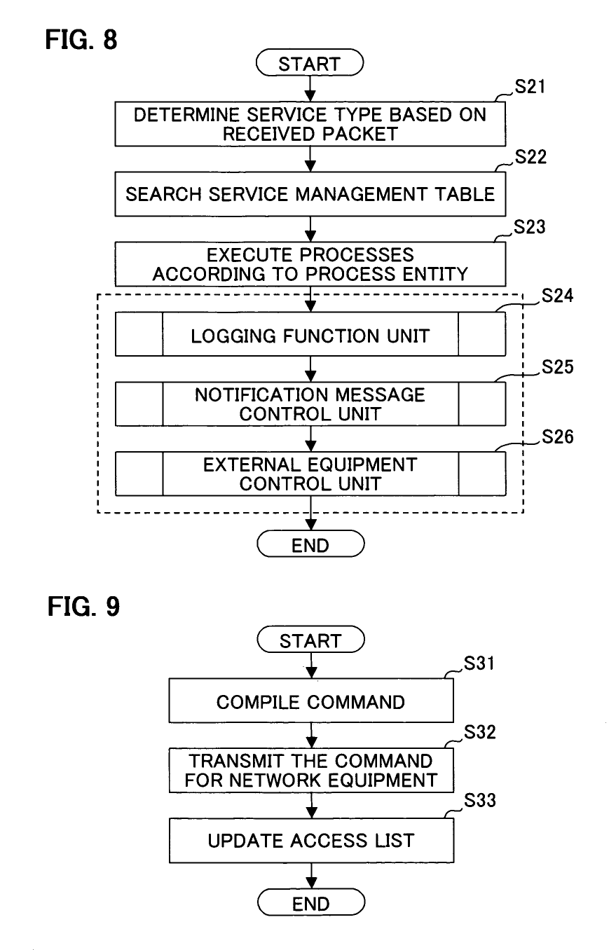

The service control unit 16 is started up by the packet monitoring unit 13 and executes necessary service control based on the packet information notified of from the packet monitoring unit 13. FIG. 8 is a flowchart showing the process flow of the service control unit 16.

The service control unit 16 determines the service type based on the reception port number of the received packet notified of from the packet monitoring unit 13 (S21). According to the IP protocol, a service can be identified based on the reception port number of a communication protocol (such as TCP/UDP). Therefore, the service types are determined based on the reception port number.

Then, the service control unit 16 analyzes the received packet by analyzing the service-specific protocol set in the payload portion of the received packet referring to the protocol library 15, and determines an event based on the message type (generally, Request or Reply) contained in the analyzed information. Then, the service control unit 16 searches the service management table 14 with the determined service type and the event (S22).

Then, the service control unit 16 executes processes according to the process entity indicated by the entry retrieved by the service control data (S23). The process entity is, for example, a program in which a process code is described for each service and event and the process differs by combination of a service and an event. Some examples of services will be presented in the application examples described later.

Next, when the service control unit 16 executes logging of information in the process by the process entity, the unit 16 starts up the logging function unit 17 and causes the logging function unit 17 to execute the logging process (S24).

When the service control unit 16 needs other network equipment, notifying the server of information, exchanging of protocols etc. in the process of the process entity, the unit 16 starts up the notification message control unit 18 and causes the notification message control unit 18 to execute these processes (S25).

Furthermore, when the service control unit 16 needs control such as setting of packet filters to (any of) the network equipment 41-4n in the process of the process entity, the unit 16 starts up the external equipment control unit 110 and causes the external equipment control unit 110 to execute the process.

The logging function unit 17 is an additional function unit for extending the range of the services provided by the PNCU 1 and has functions for extracting arbitrary piece of information from the various information contained in the captured packets and compiling the extracted information as a log message. In compiling the logging information, it is possible to provide fine-grained services specialized in particular services compared to the ordinary protocol monitors since the compiling logic can be easily incorporated. The details of the processes differ by service.

The notification message control unit 18 is also an additional function unit for extending the range of the services provided by the PNCU 1 and has functions for notifying other service servers and network equipment of specific information of the captured packets and exchanging information. The details of the processes differ by service.

The logging function unit 17 and the notification message control unit 18 are additional function units for facilitating the processes of the process entity referred to from the service control data 14. It is possible to cut out the common functions among the process entities and add them as new function units in addition to these function units.

The external equipment control unit 110 is started up by the service control unit 16 and sends control commands to corresponding network equipment based on the information notified of from the service control unit 16. FIG. 9 is a flowchart showing the process flow of the external equipment control unit 110.

The external equipment control unit 110 identifies the network equipment to be controlled based on the information notified of from the service control unit 16 and compiles the control commands specific to the identified network equipment using the information notified of from the service control unit 16 and the CLI library 112 (S31).

Then, the external equipment control unit 110 transmits the command compiled for the identified network equipment (external equipment) using the CLI library 112 according to the network-apparatus-specific protocol (for example, Telnet) (S32).

Finally, when the transmission (setting) of the command to the network equipment is completed successfully, the external equipment control unit 110 registers in the access list 111 the IP address of the user terminal being the target for setting, setting information necessary later for changing the setting information, setting status and addresses of the external equipment for which information has been set (S33) and ends the processes.

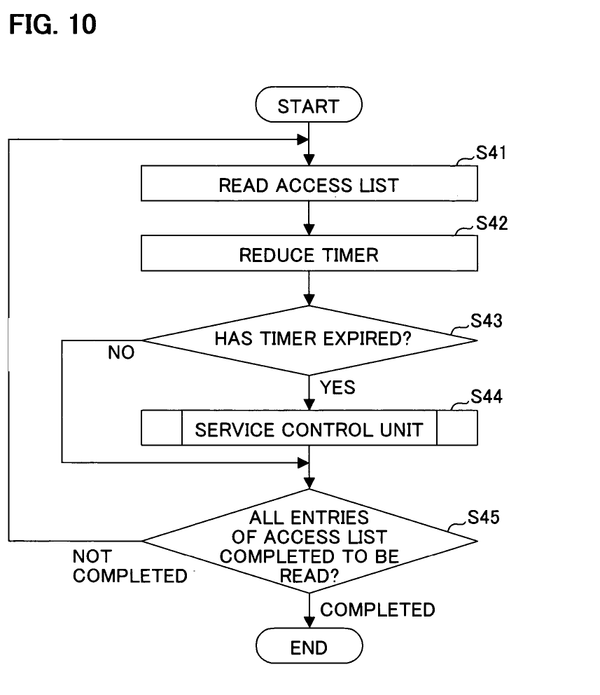

The periodic process unit 19 is started up first by the initial setting process unit 12 and will be started up later on periodically using an approach such as signal interruption. The periodic process unit 19 manages a timer set in an entry of the access list 111 and, when the timer expires, notifies the service control unit 16 of the timer expiration event. FIG. 10 is a flowchart showing the process flow of the periodic process unit 19.

The periodic process unit 19 reads the access list 111 (S41) and reduces a timer set in an access list entry (S42).

Then, the periodic process unit 19 checks whether or not the timer has expired (S43) and, when the timer has expired (YES of S43), the unit 19 creates a timeout event based on information set in the entry and starts up the service control unit 16 (S44). On the other hand, when the timer has not expired, the periodic process unit 19 skips the process of Step S44.

Then, the periodic process unit 19 determines whether or not the process of all the entries of the access list 111 has been completed (S45) and, when the process of all the entries has completed, the unit 19 ends the process. When the process has not been completed, the unit 19 repeats the processes of Step S41-44.

Next, in order to clarify the advantages of the PNCU 1, the PNCU 1 will be described referring to application examples in which the PNCU 1 is applied to some services, comparing with the examples in which the services are performed with the conventional technical solutions.

<First Example of Application>

As the first application example, an example of a service for performing access regulation by the PNCU 1 in a network utilizing a DHCP (Dynamic Host Configuration Protocol) server will be described.

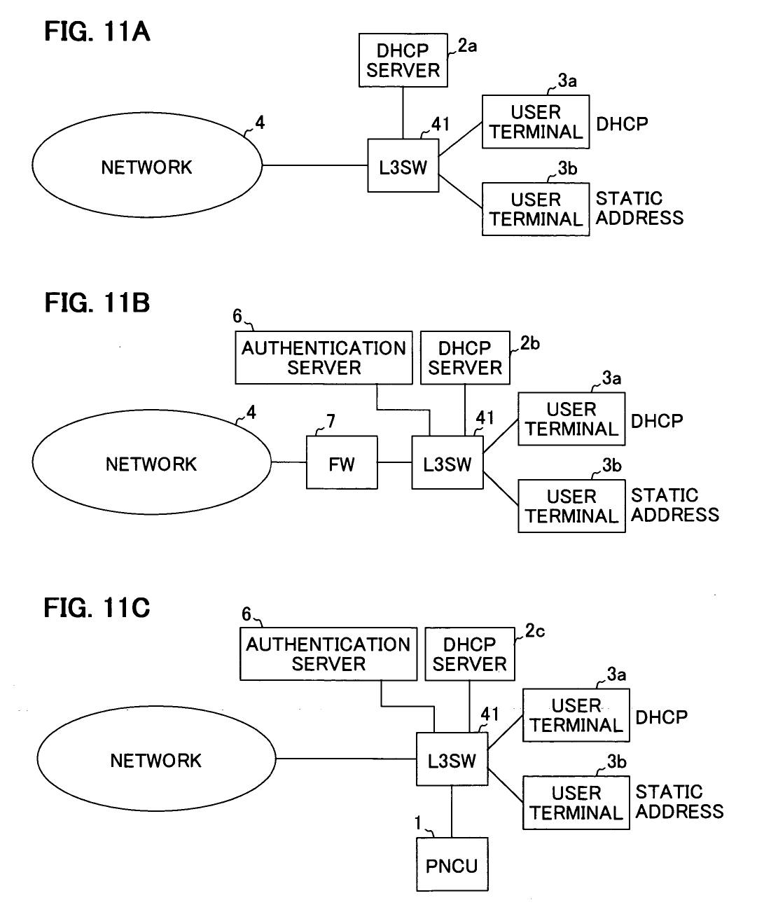

FIG. 11 illustrates problems of a network in terms of security, that arise when address allocation (paying out) to a user terminal is executed by the DHCP server. FIG. 11B is a configuration diagram of a network system for the case where the problem is solved by the conventional technique. FIG. 11C is a configuration diagram of a network system for the case where the problem is solved by the PNCU 1.

The PNCU 1 can be incorporated in the network in any of the configurations shown in FIGS. 1A to 1D. However, in FIG. 1C, the configuration according to the configuration example 3 shown in FIG. 1C as an example.

In FIG. 11, DHCP servers 2a-2c and the authentication server 6 correspond to the service server 2 shown in FIGS. 1A to 1D and a L3SW 41 corresponds to the network equipment 41 shown in FIGS. 1A to 1D. Furthermore, user terminals 3a and 3b correspond to the user terminal 3 shown in FIGS. 1A to 1D.

First, referring to FIG. 11A, in a network operating the DHCP server 2a, a user terminal utilizing the DHCP like the user terminal 3a obtains automatically an IP address and other information from the DHCP server 2a and accesses to the network 4.

The DHCP server 2a commonly has a function for allocating (paying out) IP addresses to the user terminals registered. When all the user terminals connected with the network is set to utilize the DHCP, user terminals not registered in the DHCP server 2a are not paid with the IP addresses from the DHCP server 2a. Therefore, a user terminal attempting to make an unauthorized access can not obtain any IP address and can not make any access to the network.

However, when the user terminal 3b attempting to make an unauthorized access can learn the information paid out by the DHCP server 2a in a certain approach, the user terminal 3b can connect with the network and communicate by directly setting an IP address and a default route without utilizing the DHCP. This is because a regulation that only the IP addresses paid out by the DHCP server 2a can pass is not set to network equipment (in this case, L3SW 41) connecting a local network that the user terminal is connecting with and an external network.

As a method to solve this problem, as shown in FIG. 11B, a method has been proposed, in which only the IP addresses paid out by the DHCP server can pass through by combining the DHCP server, the authentication server and a firewall (FW).

First, the user terminal 3a utilizing the DHCP obtains a temporary address for communicating with the authentication server 6 from a DHCP server 2b. Then, the user terminal 3a accesses to the authentication server 6 using this temporary address and receives authentication.

After authentication, the user terminal 3a requests the DHCP server 2b to pay out a regular address for accessing to and communicating with a network. The DHCP server 2b is cooperating with the authentication server 6 and asks the authentication server 6 whether or not the user terminal 3a having requested the paying out of the address has finished its authentication.

When the user terminal 3a has finished its authentication, the DHCP server 2b sets to a FW 7 such that the FW 7 releases the regulation of the regular address paid out to the user terminal 3a and pays out this regular address to the user terminal 3a.

On the other hand, since the user terminal 3b not utilizing the DHCP does not have any address paid out by the DHCP server 2b, an access made by the terminal 3b can not pass through the FW7 and cannot access to and communicate with the network.

As described above, in the case where the problems are solved according to the conventional method, a special apparatus that can make settings of FW7 is necessary as the DHCP server 2b, and a special apparatus that can receive the setting by the DHCP server 2b is also necessary as the FW 7. Therefore, by introducing an FW, it is necessary to change the DHCP server to a special one or replace it with a DHCP server capable of being used in combination with an FW. Though there is a method in which the authentication server and an FW cooperates with each other as another method, a special apparatus as the authentication server is necessary also in this method. Therefore, the existing apparatuses can not be used as they are.

In contrast, in the case where the PNCU 1 is utilized, as shown in FIG. 11C, the access regulation can be performed only by connecting the PNCU 1 with the L3SW 41 and the existing DHCP server 2c and the existing authentication server 5 (as well as the L3SW 41) can be used.

FIG. 11C shows an example in which the access regulation is executed by using the DHCP server 2c, the authentication server 6 and the L3SW 41 without using any FW. In this case, it is assumed that the L3SW 41 has a function for passing only the packets with addresses having been set.

First, the user terminal 3a utilizing the DHCP obtains a temporary address for communicating with the authentication server 6 from the DHCP server 2c. Then, the user terminal 3a accesses to the authentication server 6 using this temporary address and receives authentication.

After authentication, the user terminal 3a requests to the DHCP server 2c paying out of a regular address. The DHCP server 2c is cooperating with the authentication server 6 and asks the authentication server 6 whether or not the user terminal 3a having requested the paying, out of the address has finished its authentication. When the authentication has been finished, the DHCP server 2c pays out a regular address to the user terminal 3a.

PNCU 1 is connected with a monitoring interface of the L3SW 41 and monitors all the packets passing through the L3SW 41. Then, when the PNCU 1 has captured a response message containing the paid out address, the PNCU 1 analyzes the response message.

When the response message is normal and contains a regular address, the PNCU 1 make settings to the L3SW 41 such that the L3SW 41 releases the regulation of the regular address contained in the response message.

On the other hand, as described above, the user terminal 3b not utilizing the DHCP has not been paid out with the address by the DHCP server 2c. Therefore, the access of the user terminal 3b can not pass through the L3SW 41 and can not access to the network.

As described above, the advantage of the case where the PNCU 1 is used is to be able to perform access regulation by utilizing network equipment (for example, an L3SW) having an access function equal to that of a firewall, if such network equipment is already present, without introducing a special DHCP server, a special authentication server, a special firewall etc. Furthermore, according to the scheme of the invention, it is possible to cope with the case where the DHCP server does not cooperate with the authentication server and has only a function for simple authentication such as MAC address authentication.

Access regulation cooperating with the DHCP procedure using the PNCU 1 shown in FIG. 11C will be described in details.

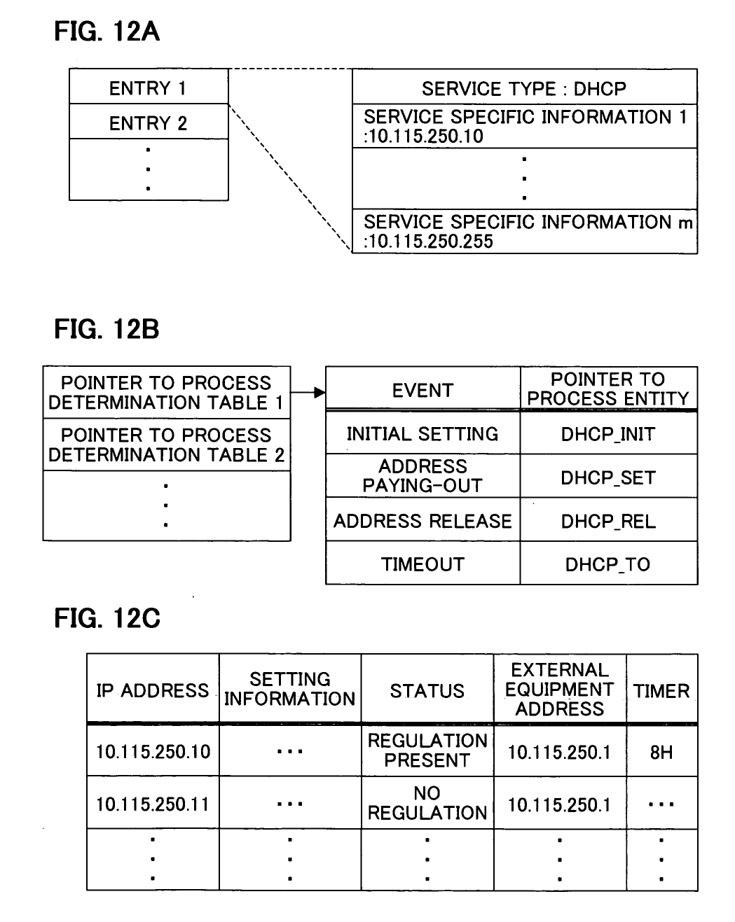

FIGS. 12A, 12B and 12C show respectively an example of the address list 11, the service management table 14 and the access list 111.

When the PNCU 1 has been started up, as described above, first, the initial setting process unit 12 is started up and the address list 11 is read by the initial setting process unit 12 (S1 in FIG. 6).

In the address list 11 (see FIG. 12A), DHCP is registered as a service type and a list of IP addresses to be paid out by the DHCP server is registered as service-specific information.

Since the service type is DHCP, the initial setting process block 12 searches the DHCP process determination table of the service management table 14 (see FIG. 12(B)) with an event “initial setting” (S2 in FIG. 6) and executes the process entity indicated at the searched destination (for example, a program denoted by DHCP_INIT) (S3 in FIG. 6).

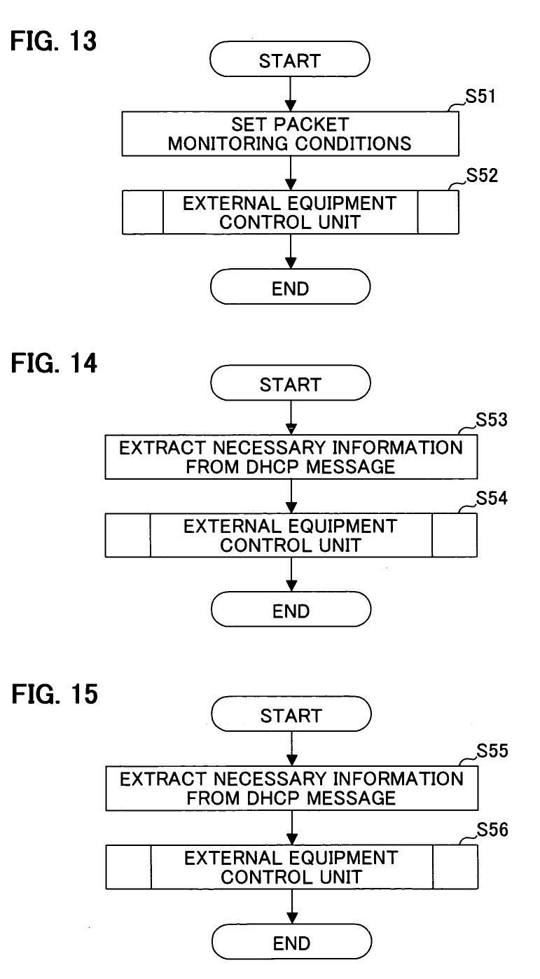

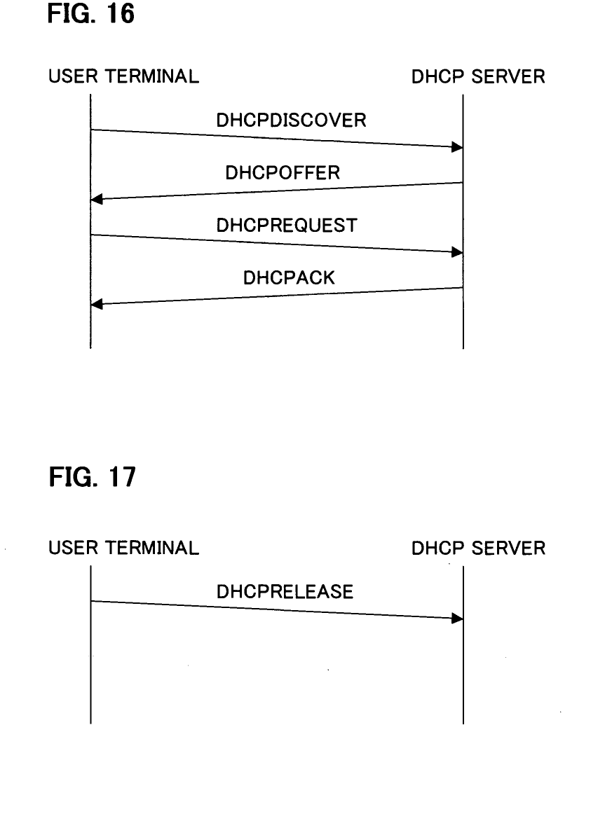

FIG. 13 is a flowchart showing the process flow of DHCP_INIT. In the process of DHCP_INIT, the packet monitoring conditions of the packet monitoring unit 13 are set (S51). The detailed setting conditions are those with the destination numbers 67 (bootp server) and 68 (bootp client) of a UDP packet.

Next, the external equipment control unit 110 is started up for each IP address in the IP address list of the address list 11 (see FIG. 12A) and regulation information of the initial setting is set (S52). The information to be set is, for example, DNS (Domain Name System) and regulation of all the packets except the DHCP.

When the DHCP-specific initial setting process has been completed, the initial setting process unit 12 starts up the packet monitoring unit 13 and the periodic process unit 19 (S5 and S6 in FIG. 6).

The packet monitoring unit 13 monitors all the packets received by the monitoring interface (S11 of FIG. 7) and, when the unit 13 has received a packet matching the monitoring conditions, it starts up the service control unit 16 (S12-S14 in FIG. 7). The monitoring conditions are those with the UDP destination port number 67 and 68. The condition of UDP destination port number 67 is DHCPDISCOVER and DHCPREQUEST in the sequence diagram shown in FIG. 16. The condition of UDP destination port number 68 is DHCPOFEER and DHCPPACK in the sequence diagram.

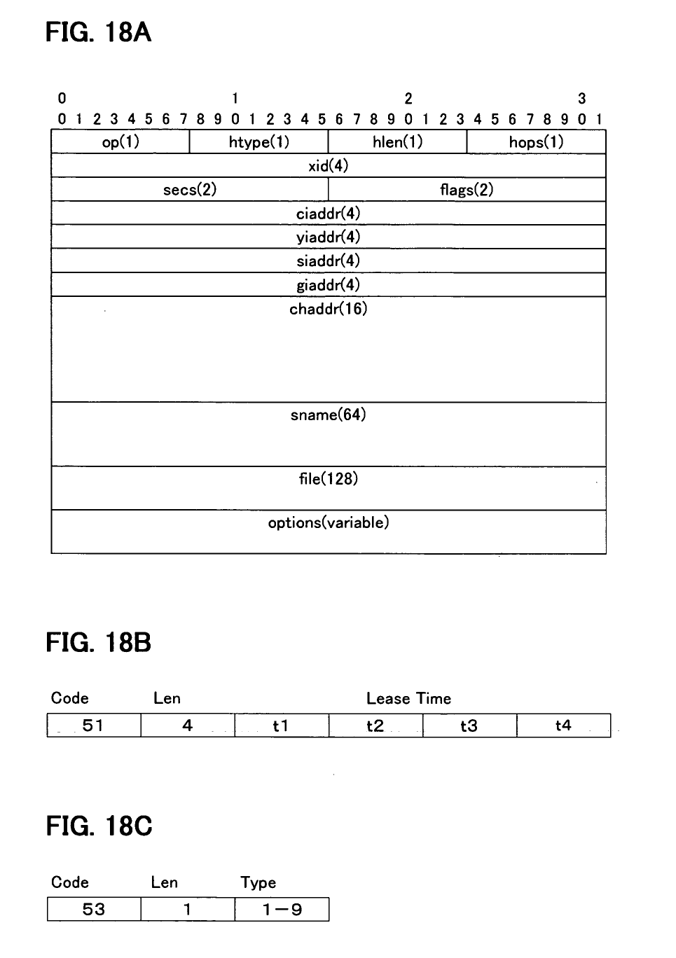

Since the UDP destination port number of the received packet is 67 or 68, the service control unit 16 identifies that the packet is a DHCP message. Then, the service control unit 16 determines an event referring to a DHCP message type option (see FIG. 18C) of the DHCP message having a format shown in FIG. 18A.

When the message type is DHCPACK, the service control unit 16 determines the event to be address paying-out (S21 in FIG. 8). Furthermore, since the service type is DHCP, the service control unit 16 searches the DHCP process determination table of the service management table 14(see FIG. 12B) with event=“address paying-out” (S22 in FIG. 8.). The process of the process entity (for example, a program DHCP_SET) indicated in the searched destination is executed (S23 in FIG. 8).

FIG. 14 is a flowchart showing the process flow of DHCP_SET. In the DHCP_SET, first, the received DHCPACK message is analyzed and the necessary information is extracted (S53). That is, the IP address paid out from the DHCP server to the user terminal is extracted from the yiaddr field shown in FIG. 18A and the expiration time of the IP address is extracted from the IP Address Lease Time field shown in FIG. 18B.

Then, the external equipment control unit 110 is started up using the extracted IP address and the expiration time as parameters and the external equipment control unit 110 releases the regulation of the external equipment (L3SW 41) corresponding to the IP address (S54). For example, release of the regulation on all the protocols of the external equipment corresponding to the IP address.

The external equipment control unit 110 compiles a command to be set to the external equipment based on the parameters delivered from the DHCP_SET (S31 in FIG. 9). Then, the external equipment control unit 110 determines the external equipment to which the control commands are sent based on the network prefix of the IP address delivered from the DHCP_SET or the apparatus in formation registered in advance and the commands are sent to the external equipment (S32 in FIG. 9).

When the external equipment control unit 110 has finished the setting procedure of the control commands, the unit 110 registers the contents of the setting in the access list 111 (see FIG. 12C) (S33 in FIG. 9). More specifically, the IP address of the user terminal is set in the column for IP address, “No Regulation” is set in the column for condition, the IP address of the external equipment to which the regulation information has been set is set in the column for external equipment address and the expiration time of the address is set in the column for timer.

When an address is returned, the processes as follows are executed.

Similarly as above, the monitoring conditions of the packets of the packet monitoring unit 13 are those with the UDP destination port number 67 and 68. As shown in the sequence diagram shown in FIG. 18, the message DHCPRELEASE transmitted from the user terminal to the DHCP server when the address is returned has a UDP port number 67.

The service control unit 16 identifies the packet to be the message of the DHCP since the received packet has a UDP destination port number of 67 and determines an event referring to a DHCP message type option (see FIG. 18C) of the DHCP message.

Then, when the message type is DHCPRELEASE, the service control unit 16 determines the event to be address release (S21 in FIG. 8). Since the service type is DHCP, the service control unit 16 searches the DHCP process determination table of the-service management table 14(see FIG. 12B) with event=“address release” (S22 in FIG. 8) and executes the process of the process entity (for example, a program DHCP_REL) indicated by the searched destination (S23 in FIG. 8).

FIG. 15 is a flowchart showing the process flow of DHCP_REL. In DHCP_REL, first, the received DHCPRELEASE message is analyzed and necessary information is extracted from the message (S55). That is, the IP address to be released is extracted from the ciaddr field shown in FIG. 18A. The external equipment control unit 110 is started up using the extracted IP address as parameters and the regulation of the external equipment corresponding to the IP address is released (S56). Regulation conditions same as those for the initial setting is set.

The external equipment control unit 110 compiles the commands to be set to the external equipment based on the parameter delivered from DHCP_REL (S31 in FIG. 9). Furthermore, the external equipment control unit 110 determines the external equipment to which the control commands are sent based on the network prefix of the IP address delivered from DHCP_REL or the apparatus information registered in advance and send out the command to the external equipment (S32 in FIG. 9).

When the setting procedure of the control command has been finished, the external equipment control unit 110 changes the contents of the access list setting (S33 in FIG. 9). More specifically, “Regulation Present” is set in the column for the status of the corresponding IP address entry and “invalid” is set in the column for address expiration time.

The access regulation accompanying the expiration of the release term of the address can be set by the process of the periodic process unit 19.

The periodic process unit 19 monitors the access list periodically and reduces the timer being set. When the timer has been expired, the periodic process unit 19 notifies the service control unit 16 of the timer expiration event based on the setting information of the entry of the access list 111 (S41-S44 in FIG. 10).

The service control unit 16 determines the service type=“DHCP” and event=“timeout” by the notified timer expiration event (S21 in FIG. 8). Then, since the service type is DHCP, the service control unit 16 searches the DHCP process determination table of the service management table 14 with event=“timeout” (S22 in FIG. 8) and executes the process of the process entity (for example, a program DHCP_REL) indicated by the searched destination (S23 in FIG. 8).

The processes after this are same as the processes of above DHCPRELEASE message except that the information is extracted not from the DHCPRELEASE message but internal event information (timer expiration event).

In this manner, the access regulation service cooperated with the DHCP procedure can be performed by using the PNCU 1 without changing the existing network resources.

As described above, the PNCU 1 may be connected with the network in the configuration shown in FIGS. 1A, 1B or 1C or it may be integrated in the DHCP server 2c. In the case where the PNCU 1 is integrated in the DHCP server 2c, the functions of the PNCU 1 may be stored in the DHCP server 2c by realizing them by a program and this program may be run by a CPU in the DHCP server 2c.

<Second Example of Application>

The second application example is a case where the PNCU 1 is applied to a packet passing regulation release of a firewall (FW) according to a mobile communication protocol, Mobile IPv4.

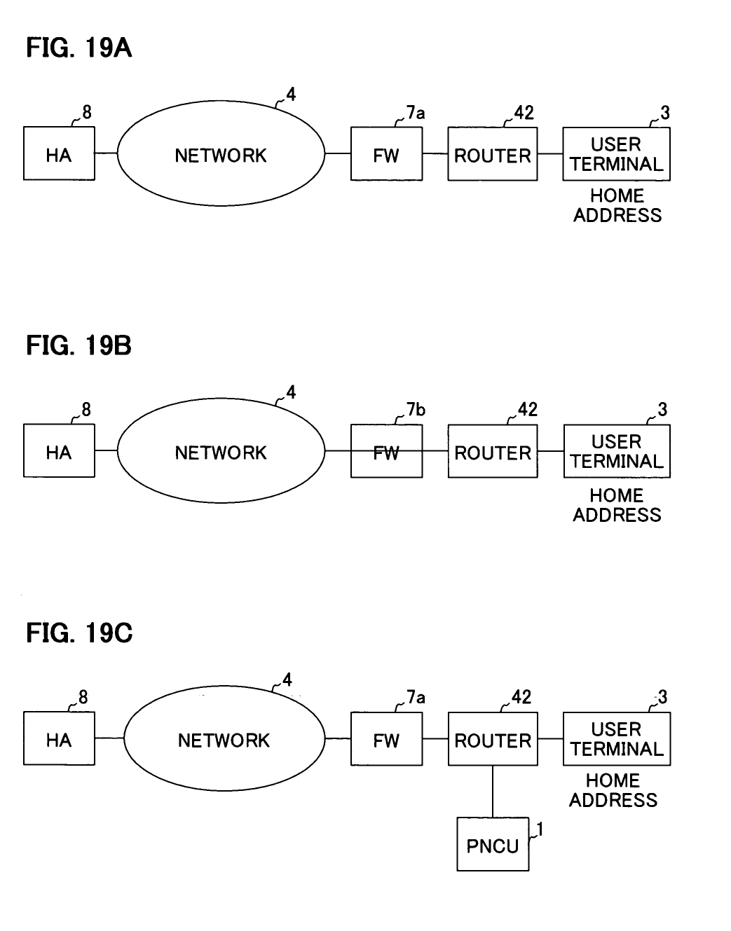

FIG. 19A illustrates a problem arising in the case where an FW is installed according to Mobile IPv4. FIG. 19B is a configuration diagram of a network system for the case where the problem is solved by the conventional technique. FIG. 19C is a configuration diagram of a network system for the case where the problem is solved by the PNCU 1.

The PNCU 1 can be incorporated in the network in any of the configurations shown in FIGS. 1A to 1D. However, in FIG. 19C, only the configuration according to the configuration example 3 shown in FIG. 1C is shown as an example.

In FIGS. 19A to 19C, the user terminal 3 is a mobile terminal (such as a cellular phone) and has an address of its home network of a home agent (HA) 8 as a home address. A router 42 is network equipment arranged on a foreign network and may be a foreign agent. A firewall (FW) 7a or 7b is connected between the router 42 and the network 4. The user terminal 3 is moving from the home network to the foreign network.

In FIG. 19A, FW 7a checks the sender address of a packet transmitted from the router 42 to the network 4 (i.e., from a foreign network to the network 4) and, when the sender address is an address not originally present in the foreign network, may be set such that the FW 7a causes the packet not to pass through the FW 7a.

The user terminal 3 retains the home address and a care of address obtained on the foreign network. When the user terminal 3 registers in the HA 8 the correspondence of the home address and the care of address, communication is performed using the care of address. On the other hand, the user terminal 3 transmits ordinary data packets such as email, starting point address of the IP packet is set in the home address.

Therefore, when the above setting of a FW has been completed, a problem arises, that the packet transmitted when the address correspondence is registered in the HA 8 can pass through the FW 7a while the ordinary data packets can not pass through the FW 7a and the user terminal 3 can not communicate with the counterpart terminal.

In order to solve this problem, methods have been proposed in which the IP packets transmitted by the user terminal 3 are encapsulated by care of addresses or the setting of the FW 7a is dynamically changed.

FIG. 19B shows a method for changing dynamically the setting of FW 7b. The FW 7b monitors the packets passing through it, captures a Registration Reply message being the location registration response message of the Mobile IPv4, compares the result code in this message with the home address and, when the result is “normally finished”, makes settings for releasing the access regulation of the home address.

As another method for realizing, there is a scheme in which an authentication server executes hole-making at an FW in cooperation with another server.

In either method, it is necessary to install in the network a special firewall or a combination of a specific authentication server and a specific firewall and, in a network that has not been using the Mobile IPv4, it is impossible to add any function for passing through a firewall without any change in the network configuration.

In contrast, in the case where the PNCU 1 is utilized, as shown in FIG. 19C, it is possible to solve the problem of passing through firewalls only by connecting the PNCU 1 with the router 42 and there is no need to use any specific apparatus as an FW and there is no need to change the configuration of the network.

In FIG. 19C, the PNCU 1 monitors the packets (the messages according to the Mobile IPv4) passing through the router 42 and obtains the home address of the user terminal 3. Then, the PNCU 1 controls the FW 7a such that it passes the packets having the home address of the user terminal 3.

Therefore, when the PNCU 1 is used, there is no need to replace the FW 7a with a special firewall and there is no need to change the configuration of the network.

A method for solving the problem of passing through firewalls according to the Mobile IPv4, using the PNCU 1 shown in FIG. 19C will be described in detail.

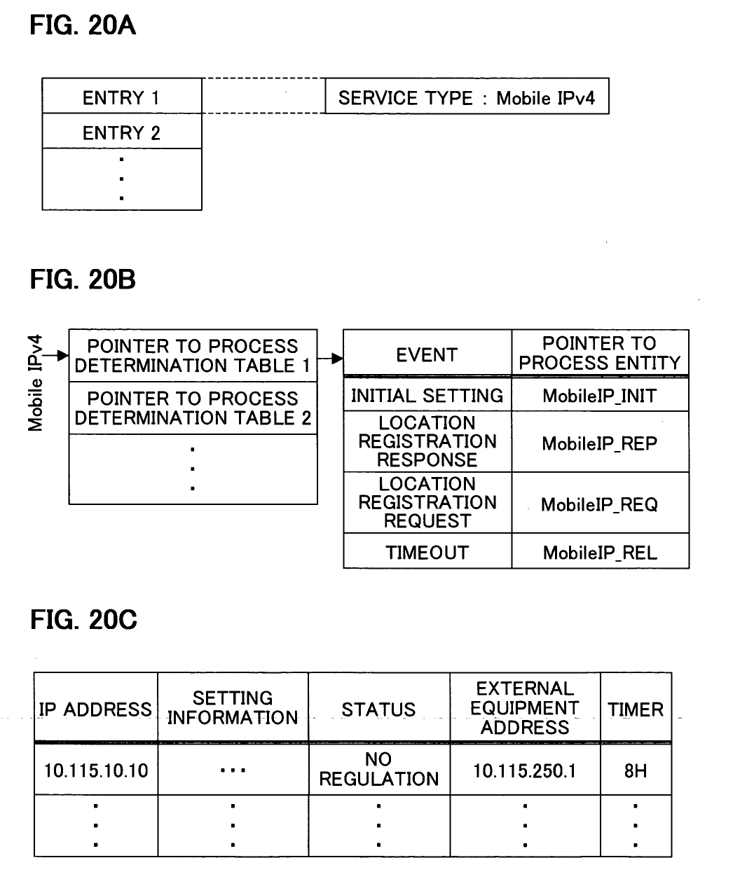

FIG. 20A shows an example of the address list 11. FIG. 20B shows an example of the service management table 14. FIG. 20C shows an example of the access list 111.

When the PNCU 1 has been started up, as described above, first, the initial setting process unit 12 is started up and the address list 11 is read into the unit 12 (S1 in FIG. 6). The Mobile IPv4 is registered as a service type in the address list 11 (see FIG. 20A). There is no service-specific information. Since the service type is the Mobile IPv4, the initial setting process unit 12 searches the Mobile IPv4 process determination table of the service management table 14 with event=“initial setting” (S2 in FIG. 6).

Then the initial setting process unit 12 executes the process of the process entity (for example, a program, Mobile_INIT) indicated at the searched destination (S3 in FIG. 6).

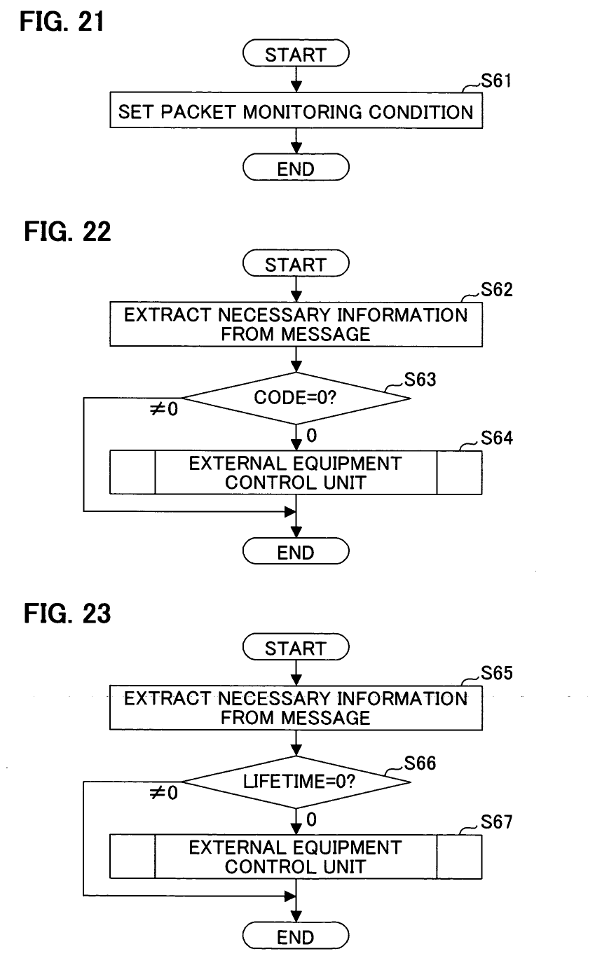

FIG. 21 is a flowchart showing the process flow of MobileIP_INIT. According to MobileIP_INIT, the packet monitoring unit 13 is set with the conditions for monitoring packets (S61). The detailed setting conditions are the sender of the UDP packet and its destination port number 434 (Mobile IPv4).

When the initial setting process unit 12 has finished the initial setting process of MobileIP, it starts up the packet monitoring unit 13 and the periodic process unit 19 (S5 and S6 in FIG. 6).

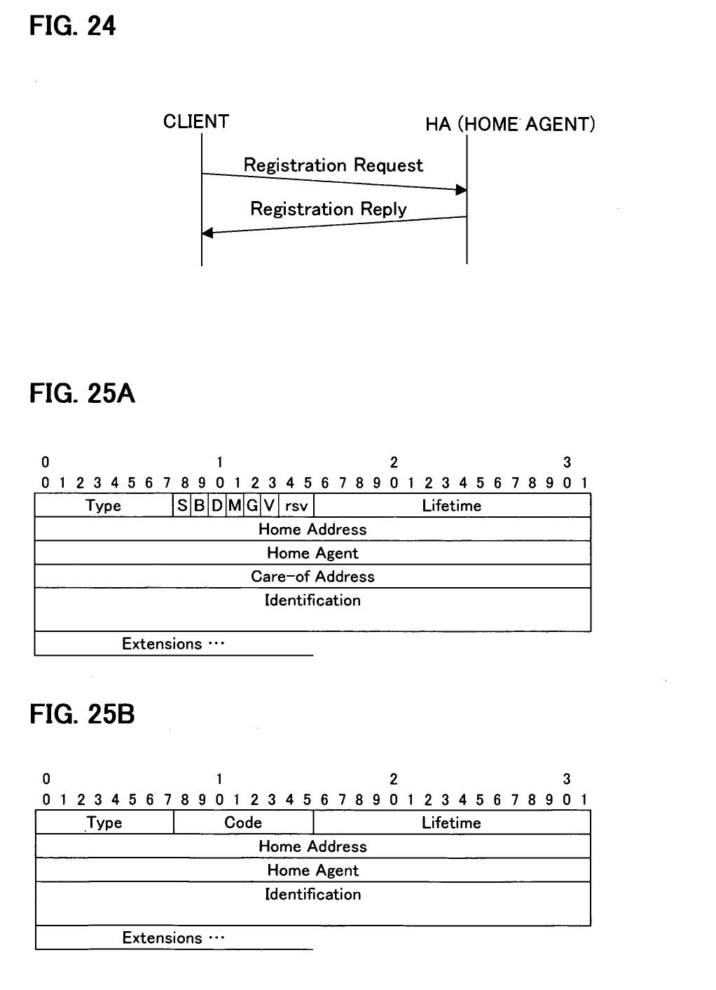

The packet monitoring unit 13 monitors all the packets received by the monitoring interface (S11 in FIG. 7) and, when it has received a packet meeting the monitoring conditions, starts up the service control unit 16 (S12-S14 in FIG. 7). The monitoring conditions are the sender of the UDP and its destination port number 434. The packet meeting the destination port number 434 is “Registration Request” in the location registration sequence diagram of Mobile IPv4 shown in FIG. 24 and the packet meeting the sender port number 434 is “Registration Reply”.

The service control unit 16 identifies the received packet to be a message according to Mobile IP from the UDP sender and the destination port number 434 of the received packet and determines an event by referring to the message type (Type) of Mobile IPv4 message (see FIGS. 25A and 25B).

When the message type is Registration Replay, the service control unit 16 determines the event to be a location registration response (S21 in FIG. 8). Since the service type is Mobile IPv4, the service control unit 16 searches the Mobile IPv4 process determination table of the service management table 14 (see FIG. 20B) with event=“location registration response” (S22 in FIG. 8). Then, the service control unit 16 executes the process of the process entity (for example, a program, MobileIP_REP) indicated at the searched destination (S23 in FIG. 8).

FIG. 22 is a flowchart showing the process flow of MobileIP_REP. According to MobileIP_REP, first, the received Registration Reply message is analyzed and the necessary information is extracted (S62).

That is, the process result of the location registration is extracted from the Code field shown in FIG. 25B and the IP address of the terminal for which the regulation is to be released is extracted from the Home Address field shown in FIG. 25B. The expiration time of the location registration is extracted from the Lifetime field shown in FIG. 25B.

When the value of the Code field is the value indicating a normal response (i.e., zero (0)) (zero (0) in S63), the external equipment control unit 110 is started up and the regulation is released for the external equipment corresponding to the IP address (S64). On the other hand, when the value of the Code field is not the value indicating a normal response (≠0 in S63), the process is ended.

The information to be set using the extracted IP address and the expiration time as parameters is, for example, the release of regulation on all the protocols for the IP address.

The external equipment control unit 110 compiles the commands to be set to the external equipment, from the parameters delivered from MobileIP_REP (S31 in FIG. 9). Then, the external equipment control unit 110 determines the external equipment to be sent the control commands to based on the apparatus information registered in advance and send out the commands to the external equipment (S32 in FIG. 9).

When the setting procedure of the control commands has finished, the unit 110 registers the contents of the setting in access list 111 (S33 in FIG. 9). More specifically, the IP address of the user terminal is set in the column for IP addresses and “no regulation” is set in the column for status. Furthermore, the IP address of the external equipment having been set with the regulation information is set in the column for the external equipment address and the expiration time of the address is set to the timer.

In the location registration sequence diagram shown in FIG. 24, the explicit finishing procedure of Mobile IP is performed by transmitting a message for which the Lifetime field (see FIG. 25A) of the Registration Request message is set to zero (0).

The service control unit 16 identifies the received packet to be a message of Mobile IP, from the UDP sender of the received packet and destination port number 434 and determines an event referring to the message type of the Mobile IPv4 message.

When the message type is Registration Request, the service control unit 16 determines the event to be a location registration request (S21 in FIG. 8). Since the service type is Mobile IPv4, the service control unit 16 searches the Mobile IPv4 process determination table of the service management table 14 (see FIG. 20B), with event=“location registration request” (S22 in FIG. 8).

Then, the service control unit 16 executes the process of the process entity (for example, a program, MobileIP_REQ) indicated at the searched destination (S23 in FIG. 8).

FIG. 23 is a flowchart showing the process flow of MobileIP_REQ. According to MobileIP_REQ, first, the received Registration Request message is analyzed, the IP address of the user terminal being the target is extracted from the Home Address field and the expiration time of the location registration is extracted from the Lifetime field (S65).

When the expiration time is zero (0) (zero (0) in S66), the external equipment control unit 110 is started up and the regulation on IP addresses is performed (S67). The information to be set is release of the regulation release conditions on the corresponding IP addresses.

The external control unit 110 compiles the commands to be set to the external equipment based on the parameters delivered from MobileIP_REQ (S31 in FIG. 9). Then, the external equipment control unit 110 determines the external equipment to which the control commands are sent based on the apparatus information registered in advance and sends out the commands to the external equipment (S32 in FIG. 9). When the setting procedure of the control commands has been finished, the external equipment control unit 110 deletes the contents of the access list setting (S33 in FIG. 9).

Setting of access regulation due to the expiration of the lifetime is also executed. The periodic process unit 19 monitors the access list 111 periodically and reduces the time being set to it. When the timer has been expired, the periodic process unit 19 notifies the service control unit 16 of the timer expiration event based on the entry setting information of the access list 111 (S41-S44 in FIG. 10).

The service control unit 16 determines service type=“MobileIP” and event=“timeout” (S21 in FIG. 8). Since the service type is MobileIP, the service control unit 16 searches the MobileIP process determination table of the service-management table. 14 (FIG. 24) with event=“timeout” (S22 in FIG. 8). The unit 16 executes the process of the process entity (for example, a program, MobileIP_REL) indicated at the searched destination (S23 in FIG. 8).

The processes after this are same as the processes of above Registration Request message except that internal event information (timer expiration event) is extracted not from the Registration Request message but internal event information (timer expiration event).

In this manner, by using the PNCU 1, it is possible to connect the user terminals using Mobile IPv4 without introducing any special firewall into the network.

<Third Example of Application>

The third application example is a case where the PNCU 1 is applied to access regulation in IPv6.

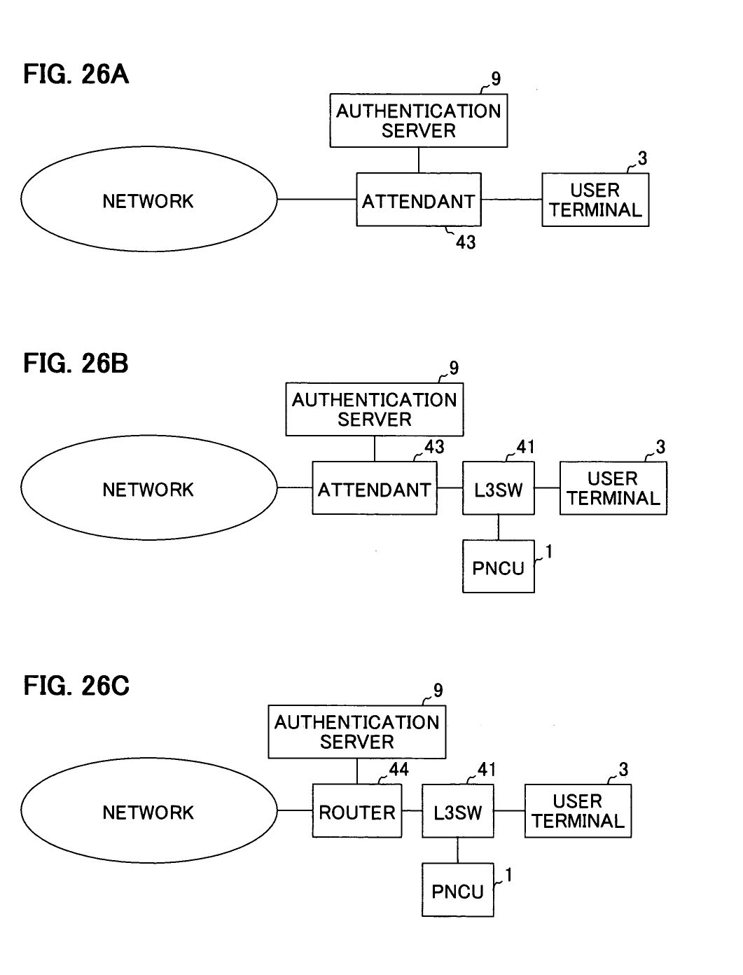

FIG. 26A shows the overview of an access regulation scheme according to IPv6 proposed in IETF (Internet Engineering Task Force). According to IPv6, there have been proposed two (2) address automatic configuration methods such as the state-full address configuration method in which addresses are created using a DHCP server same as according to IPv4, and the state-less address configuration method in which an address is automatically created by combining the advertisement of the network prefix from the router and an identifier of the terminal. According to these address automatic configuration, the same problem in terms of security as the one for DHCP of IPv4 described in the first application example arises.

As a solution, a method has been proposed in which only the users having succeeded in the authentication can access to the network. This method will be described in detail taking the state-less address automatic configuring method as an example.

The user terminal (IPv6 terminal) 3 creates an IPv6 address based on a network prefix advertised from an attendant (router) 43 being network equipment and the identifier of the user terminal 3.

After the address is created, the user terminal 3 transmits an authentication request of the created address to the attendant 43. The attendant 43 transfers the authentication request to the authentication server 9 based on an authentication protocol exchanged between the attendant 43 and the authentication server 9. The authentication server 9 responds to the attendant 43 with the authentication result. When the authentication result is “authentication successful”, the attendant 43 releases the filter regulation on the IPv6 address presented by the user terminal 3 and responds to the user terminal 3 with the authentication response message.

In a scheme proposed according to IPv6, a specific router called “attendant” is necessary. However, no router having such a function is present currently and it is expected that a long time is necessary for such a network configuration to prevail.

However, it is necessary to solve the problems of security (access regulation) immediately. According to the invention, it is possible to secure some of the functions of an apparatus called attendant on an IPv6 network or to secure the same level of security even when there is no such functions.

FIG. 26B is a block diagram showing a network configuration example of the case where the attendant 43 is present, however, the attendant 43 does not have the function for executing access regulation. In this case, similarly to the DHCP in the first application example, the PNCU 1 can set access regulation to another network equipment (S3SW 41 shown in FIG. 26B) having the access regulation function than the attendant 43 by capturing an authentication response message.

FIG. 26C shows an example of the case where only the network equipment (L3SW 41) having the access regulation function is present and no attendant function is present. In this case, the PNCU 1 captures an authentication request message transmitted from the user terminal 3 and, instead of the router 44, executes message exchange with the authentication server 9 and access regulation control. The authentication request message (the original message) transmitted from the user terminal 3 addressed to the router 44 is discarded by the router 44. After the PNCU 1 has executed the authentication process and regulation release, it returns the authentication response message to the user terminal 3 instead of the router 44.

A detailed implementation example of an attendant service in cooperation with an IPv6 address automatic configuration using the PNCU 1, shown in FIG. 26C.

The standard technique for the authentication according to IPv6 is not established currently. However, the state-less address automatic configuration based on the IETF draft will be described as an example.

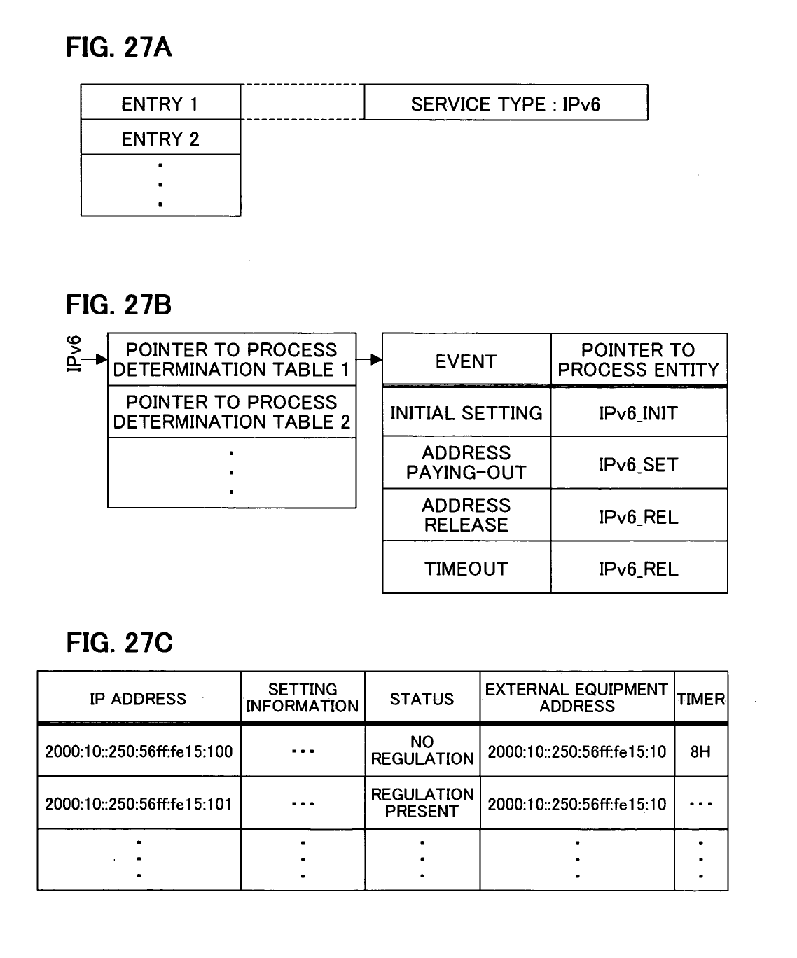

FIG. 27A shows an example of the address list 11. FIG. 27B shows an example of the service management table 14. FIG. 27C shows an example of the access list 111.

When the PNCU 1 has been started up, as already described, first, the initial setting process unit 12 is started up and the address list 11 (see FIG. 27A) is read in (S1 in FIG. 6). IPv6 is registered in the address list 11 as the service type. Any service-specific information is not provided to the address list 11.

Since the service type is IPv6, the initial setting process unit 12 searches the IPv6 process determination table of the service management table 14 (see FIG. 27B) with event=“initial setting” (S2 in FIG. 6). Then, the initial setting process unit 12 executes the process of the process entity (for example, a program, IPV6_INIT) indicated at the searched destination (S3 in FIG. 6).

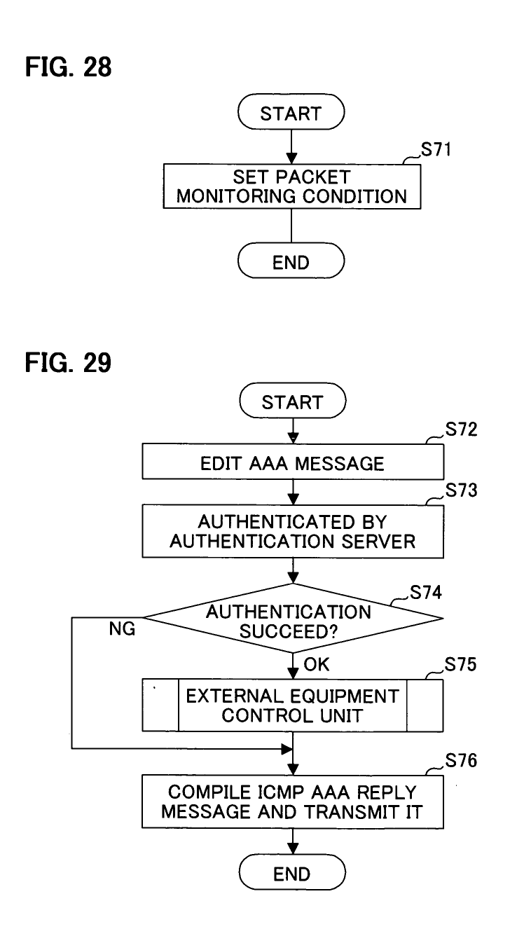

FIG. 28 is a flowchart showing the process flow of IPV6_INIT. According to IPV6_INIT, packet-monitoring condition of the packet monitoring unit 13 is set (S71). The specific setting condition is header type (protocol) equals ICMP.

When the IPv6-specific initial setting process has been finished, the packet monitoring unit 13 and the periodic process unit 19 are started up (S5 and S6 in FIG. 6).

The packet monitoring unit 13 monitors all the packets received by the monitoring interface (S11 in FIG. 7) and, when a packet matching the conditions has been received, the service control unit 16 is started up (S12-S14 in FIG. 7).

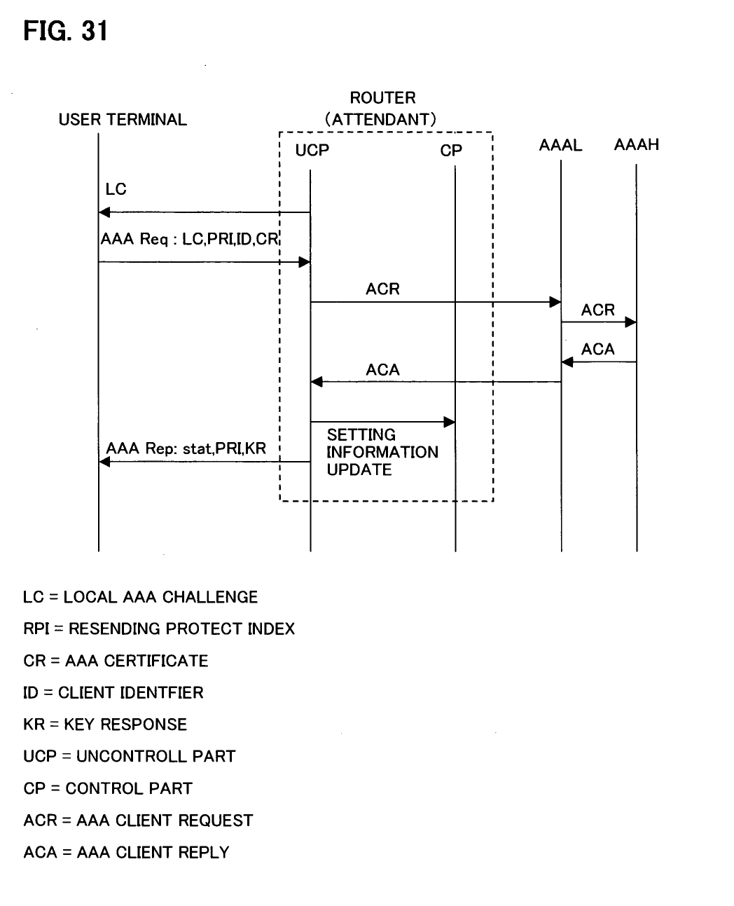

FIG. 31 is an authentication sequence diagram according to IPv6 and all the ICMP messages shown in this figure all match the monitoring conditions.

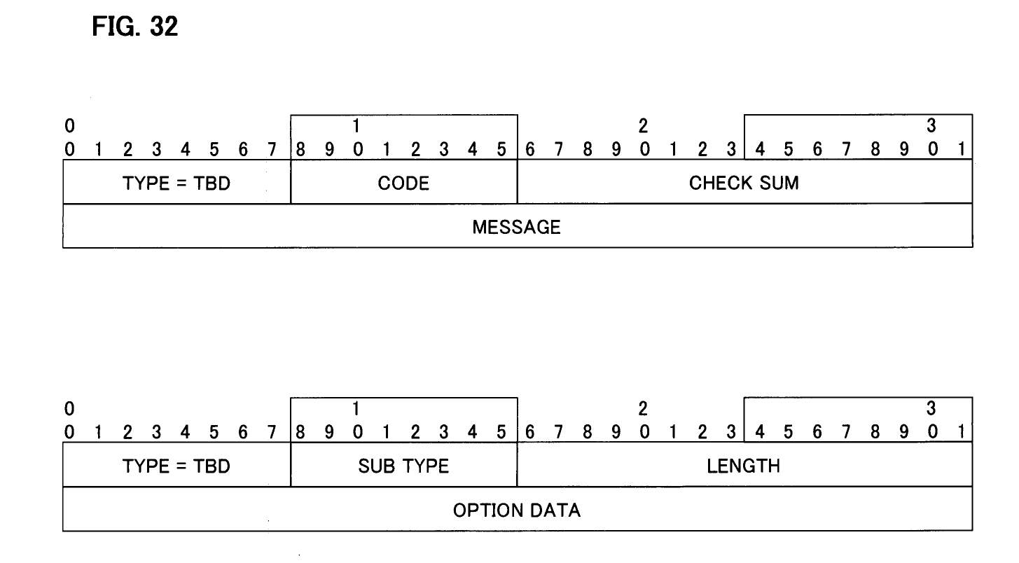

The service control unit 16 identifies the received packets to be IPv6 messages and determines an event by referring to the message type in the packet configuration of an ICMP AAA message shown in FIG. 32.

When the message type is AAA Request, the service control unit 16 determines the event to be address paying-out (S21 in FIG. 8). Since the service type is IPv6, the service control unit 16 searches the IPv6 process determination table of the service management table 14 (see FIG. 27B) with event=“address paying-out” (S22 in FIG. 8) and executes the process of the process entity (for example, a program, IPV6_SET) indicated at the searched destination (S23 in FIG. 8).

FIG. 29 is a flowchart showing the process flow of IPV6_SET. According to IPV6_SET, first, in order to receive an authentication of the corresponding user by the authentication server (AAA: Authentication, Authorization and Accounting) 9, each parameter of the ICMP AAA Request message is converted into each parameter of the AAA protocol (S72) and an authentication request is executed to the authentication server 9 (S73).

Then, the result code of the authentication response message is determined (S74) and, when the authentication is successful (“OK” in S74), the external equipment control unit 110 is started up using the extracted IP address and the expiration time as parameters and the regulation on the IP address is released (S75). The information to be set is, for example, regulation release of all the protocols for the corresponding IP address.

The external equipment control unit 110 compiles commands to be set to the external equipment from the parameters delivered by IPV6_SET (S31 in FIG. 9). Then, the external equipment control unit 110 determines the external equipment to which the control command are sent based on the apparatus information registered in advance and sends out commands to the external equipment (S32 in FIG. 9).

Then, when the setting procedure of the control commands has been finished, the external-equipment control unit 110 registers the contents of the setting of the access list 111 (S33 in FIG. 9). More specifically, the IP address of the terminal is set in the column for IP address, “no regulation” is set in the column for conditions, the IP address of the external equipment to which regulation information has been set is set in the column for the external equipment address and the address expiration time is set in the column for the timer.

Finally, ICMP AAA Reply messages are compiled and transmitted to the corresponding terminals (S76).

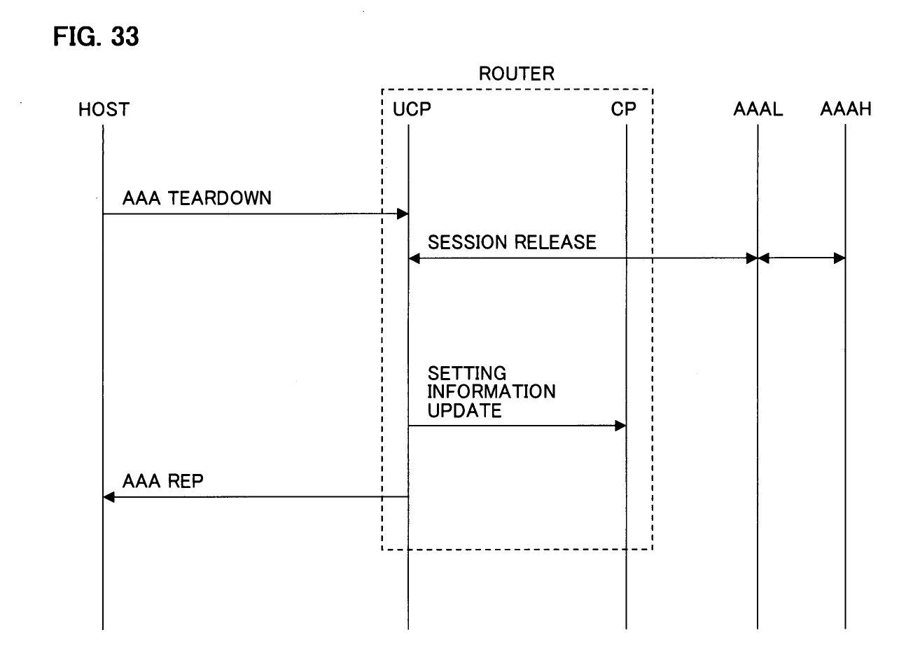

FIG. 33 shows the explicit final sequence of IPv6. The service control unit 16 determines an event referring to the message type of the ICMP AAA message. When the message type is AAA Teardown, the service control unit 16 determines the event to be address release (S21 in FIG. 8). Since the service type is IPv6, the unit 16 searches the IPv6 process determination table of the service management table 14 (see FIG. 27B) with event=“address release” (S22 in FIG. 8) and executes the process of the process entity (for example, a program, IPV6_REL) indicated at the searched destination (S23 in FIG. 8).

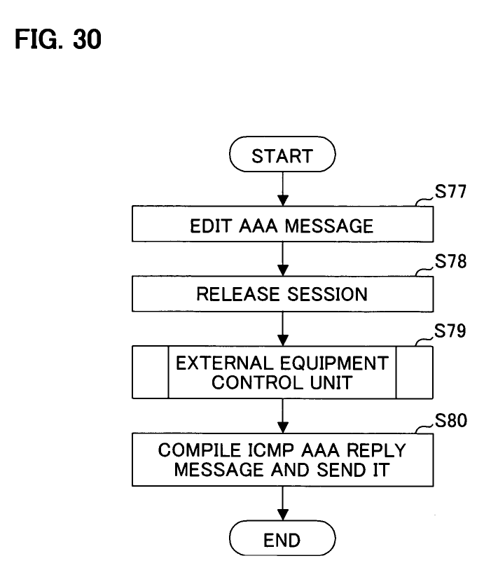

FIG. 30 is a flowchart showing the process flow of IPV6_REL. According to IPV6_REL, first, the parameters of the received AAA Teardown message are converted into an AAA protocol (S77). Then, a session is released (S78).

Then, the external equipment control unit 110 is started up and regulation on the corresponding IP address is executed (S79). The information to be set is deleting of regulation release conditions for the corresponding IP address.

The external equipment control unit 110 compiles commands to be set to the external equipment based on the parameters delivered from IPV6_REL (S31 in FIG. 9). Then, the external equipment control unit 110 determines the external equipment to which the control commands are sent based on the apparatus information registered in advance and sends out the commands to the external equipment (S32 in FIG. 9). When the setting procedure of the control commands has been finished, the external equipment control unit 110 deletes the contents of the setting of the access list 111 (S33 in FIG. 9).

Finally, ICMP AAA Reply message is compiled and is sent out to the corresponding terminal (S80 in FIG. 30).

Access regulation due to the lifetime expiration is also set. The periodic process unit 19 monitors periodically the access list 111 and reduces the timer being set. When the timer is expired, the periodic process unit 19 notifies the service control unit 16 of the timer expiration event based on the setting information of an entry of the access list 111 (S41-S44 in FIG. 10).

The service control unit 16 determines service type=“IPv6” and event=“timeout” by the notified timer expiration event (S21 in FIG. 8). Since the service type is IPv6, the service control unit 16 searches the IPv6 process determination table of the service management table 14 with event=“timeout” (S22 in FIG. 8) and executes the process of the process entity (for example, a program, IPV6_REL) indicated at the searched destination (S23 in FIG. 8).

The processes after this are same as the above processes except that the information is extracted not from the ICMP AAA Teardown message but internal event information (timer expiration event).

In this manner, by using the PNCU 1, it is possible to add easily additional services such as authentication to a network having only basic IPv6 functions.

According to the invention, it is possible to add an additional functions for new network services without changing the existing network configuration.

For example, it is possible to realize more easily and at a lower cost, the security problem arising when the DHCP is solved. According to Mobile IPv4, it is possible to solve at a lower cost the problems such as that a data packet of a user terminal present on an external network can not pass through a firewall. Furthermore, for the access regulation scheme of IPv6, it is possible to provide a function for access regulation without introducing specific apparatuses.

Yet furthermore, it becomes easier to add functions to various services by implementing on the network the proxy network control apparatus according to the invention.

While illustrative and presently preferred embodiments of the present invention have been described in detail herein, it is to be understood that the inventive concepts may be otherwise variously embodied and employed and that the appended claims are intended to be construed to include such variations except insofar as limited by the prior art.

What is claimed is:

1. A proxy network control apparatus for substituting for service equipment providing predetermined services to user terminal, and executing functions complementing or expanding the functions of the service equipment, comprising:
a packet monitoring unit for monitoring-packets interchanged between the user terminal and the service equipment; and
an execution unit for determining and executing the functions complementing or expanding, based on packets monitored by the packet monitoring unit.

2. A proxy network control apparatus for executing functions complementing or expanding functions of service equipment as a substitute for the service equipment by controlling network equipment transferring packets interchanged between a user terminal and the service equipment, arranged between the user terminal and the service equipment providing predetermined services to the user terminal, comprising:
a packet monitoring unit for monitoring packets interchanged between the user terminal and the service equipment;
a service control unit for determining the functions complementing or expanding based on the packets monitored by the packet monitoring unit; and
an external equipment control unit for controlling the network equipment based on the functions determined by the service control unit.

3. The proxy network control apparatus according to claim 2, wherein
the service equipment is a DHCP server, wherein
the packet monitoring unit monitors packets containing addresses issued from the service equipment to the user terminal, wherein
the service control unit determines an access regulation function for allowing the packets having addresses issued by the service equipment as the source addresses to pass and not allowing the packets having other addresses as the source addresses to pass, based on the packets monitored by the packet monitoring unit, and wherein
the external equipment control unit controls the network equipment-so as to execute the access regulation function.

4. The proxy network control apparatus according to claim 2, wherein
the user terminal is a mobile communication terminal having a home address of its home network, wherein
the network equipment is a firewall which allows packets having predetermined source addresses to pass and which does not allow other packets to pass among packets transmitted from an external network of the home network to the exterior, wherein
the packet monitoring unit monitors packets containing the home address of the user terminal, interchanged between the user terminal having moved into the external network and a home agent of the home network, wherein
the service control unit determines a function for releasing access regulation such that the packets having the home address are passed, based on the packets monitored by the packet monitoring unit, and wherein
the external equipment control unit controls the network equipment so as to execute the function for releasing the access regulation.

5. The proxy network control apparatus according to claim 2, wherein
the user terminal is an IPv6 terminal, wherein
the service equipment is an authentication server for executing authentication of a created IP address of the user terminal, wherein
the packet monitoring unit monitors packets containing IP addresses authenticated by the service equipment, wherein
the service control unit determines a function for releasing access regulation such that the packets having the IP addresses as the source addresses are passed, based on the packets monitored by the packet monitoring unit, wherein
the external equipment control unit controls the network equipment so as to execute the function for releasing the access regulation.

6. The proxy network control apparatus according to claim 5, further comprising an address transmission unit for creating an IP address of the user terminal and transmitting it to the user terminal, or for transmitting a network prefix to the user terminal.

7. The proxy network control apparatus according to claim 2, wherein the functions determined by the service control unit include a function for recording predetermined information.

8. The proxy-network control apparatus according to claim 2, wherein the functions determined by the service control unit include a function for transmitting messages to a predetermined network equipment or the service equipment.

9. A program for causing a computer to execute the steps of:
monitoring packets interchanged between a user terminal and service equipment providing predetermined services to the user terminal; and
determining and executing functions for complementing or expanding the functions of the service equipment based on the monitored packets, in lieu of the service equipment.

10. A program for causing a computer for executing functions complementing or expanding functions of service equipment as a substitute for the service equipment by controlling network equipment transferring packets interchanged between a user terminal and the service equipment, arranged between the user terminal and the service equipment providing predetermined services to the user terminal, to execute the steps of:
monitoring packets interchanged between the user terminal and the service equipment;
determining the functions for complementing or expanding based on the monitored packets: and
controlling the network equipment based on the determined functions.

11. A network system comprising:
service equipment for communicating with a user terminal and providing predetermined services to the user terminal; and
a proxy network control apparatus for monitoring packets interchanged between the user terminal and the service equipment and executing functions complementing or expanding the functions of the service equipment based on the packets meeting predetermined conditions.

12. The network system according to claim 11, wherein the proxy network control apparatus is integrated in the service equipment.

13. A network system comprising:
service equipment for communicating with a user terminal and providing predetermined services to the user terminal;
network equipment arranged between the user terminal and the service equipment, for transferring packets interchanged between the user terminal and the service equipment; and
a proxy network control apparatus for monitoring packets interchanged between the user terminal and the service equipment and for executing functions complementing or expanding the functions of the service equipment as a substitute for the service equipment by controlling the network equipment based on the packets meeting predetermined conditions.

14. The network system according to claim 13, wherein the proxy network control apparatus is integrated in the service equipment.

15. The network system according to claim 13, wherein the service equipment is a DHCP server, wherein
the proxy network control apparatus monitors packets containing an address distributed to the user terminal from the service equipment and controls the network equipment so as to allow the packets transmitted from the user terminal and having the address as the source address to pass and so as not to allow other packets to pass.

16. The network system according to claim 13, wherein
the user terminal is a mobile communication terminal having a home address of a home network, wherein
the network equipment is network equipment allowing the packets having a predetermined source address to pass and not allowing other packets to pass among the packets transmitted from an external network of the home network to the exterior, and wherein
the proxy network control apparatus controls the network equipment so as to pass the packets containing the home address of the user terminal as the source address, based on the packets containing the home address of the user terminal interchanged between the user terminal moved into the external network and a home agent of the home network.

17. The network system according to claim 13, wherein
the user terminal is an IPv6 terminal, wherein
the service equipment is an authentication server for authenticating created IP address of the user terminal, wherein
the proxy network unit controls the network equipment so as to allow the packets having the IP address authenticated by the service equipment as the source address to pass.

18. The network system according to claim 17, wherein the proxy network control apparatus further executes a function for creating the IP address of the user terminal and sending it to the user terminal, or for transmitting a network prefix to the user terminal.
